(19) United States
(12) Patent Application Publication
(10) Pub. No.: US 2024/0428737 A1
(43) Pub. Date: Dec. 26, 2024

(54) SEMICONDUCTOR DEVICE, DISPLAY DEVICE, AND ELECTRONIC DEVICE

(71) Applicant: Semiconductor Energy Laboratory Co., Ltd., Atsugi-shi (JP)

(72) Inventors: Manabu SATO, Oyama (JP); Hironori MATSUMOTO, Tochigi (JP); Takayuki ABE, Shimotsuga (JP); Junichi KOEZUKA, Tochigi (JP)

(21) Appl. No.: 18/742,105

(22) Filed: Jun. 13, 2024

(30) Foreign Application Priority Data
Jun. 23, 2023 (JP) 2023-103031

(51) Int. Cl. G09G 3/3241; G09G 3/3275

(52) U.S. Cl. CPC G09G 3/3241; G09G 3/3275; G09G 2300/0819

(57) ABSTRACT

A highly reliable semiconductor device or display device is provided. The semiconductor device has a function of inhibiting hot-carrier degradation of a transistor and includes a switch which includes a plurality of transistors connected in series and a diode connected to a node between the transistors. An appropriate potential supplied from the diode to the node can lower a source-drain voltage before the transistor is turned on, so that hot-carrier degradation can be inhibited.

### BACKGROUND OF THE INVENTION

### 1. Field of the Invention

One embodiment of the present invention relates to a semiconductor device.

Note that one embodiment of the present invention is not limited to the above technical field. Examples of the technical field of one embodiment of the present invention include a semiconductor device, a display device, a light-emitting apparatus, a power storage device, a memory device, an electronic device, a lighting device, an input device (e.g., a touch sensor), an input/output device (e.g., a touch panel), driving methods thereof, and manufacturing methods thereof.

In this specification and the like, a semiconductor device generally means a device that can function by utilizing semiconductor characteristics. A semiconductor element such as a transistor, a semiconductor circuit, an arithmetic device, and a memory device are each an embodiment of a semiconductor device. A display device (e.g., a liquid crystal display device and a light-emitting display device), a projection device, a lighting device, an electro-optical device, a power storage device, a memory device, a semiconductor circuit, an imaging device, an electronic device, and the like are sometimes regarded as including a semiconductor device.

### 2. Description of the Related Art

Recent display devices have been applied to a variety of uses. Usage examples of large-sized display devices include a television device for home use, digital signage, and a public information display (PID). In addition, many display devices have been used for, for example, smartphones and tablet terminals each including a touch panel.

Light-emitting apparatuses including light-emitting devices (also referred to as light-emitting elements) have been developed as display devices. Light-emitting devices utilizing electroluminescence (hereinafter referred to as EL; such devices are also referred to as EL devices or EL elements) have features such as ease of reduction in thickness and weight, high-speed response to input signals, and driving with a constant DC voltage power source. Patent Document 1 discloses an example of a display device using an organic EL element, for example.

Patent Document 2 discloses a technique in which part of a circuit included in a source driver is formed over a glass substrate like a pixel circuit in order to reduce the manufacturing cost and the mounting area of a driver IC provided in a display device.

### Reference

[Patent Document 1] Japanese Published Patent Application No. 2002-324673
[Patent Document 2] Japanese Published Patent Application No. 2019-20687

### SUMMARY OF THE INVENTION

A display device is provided with a driver circuit (a gate driver) that selects a pixel and a driver circuit (a source driver) that supplies data to the selected pixel. In addition, the display device having a touch panel function is also provided with a driver circuit for driving a touch sensor.

An IC chip is used for part or all of the driver circuits. The IC chip can be mounted on a bezel or the like of a substrate where a pixel circuit is formed; however, as the number of mounted IC chips increases, the manufacturing cost of the display device increases. This also hinders a narrower frame. In view of these problems, part or all of the driver circuits are desired to be monolithically formed over the same substrate as the pixel circuit.

To form a driver circuit, a transistor suitable for high-speed operation needs to be used. In general, it can be said that a transistor having a high on-state current is preferably used to improve charge and discharge characteristics.

An example of a means for increasing the on-state current of the transistor is to shorten the channel length; however, when the channel length of the transistor is shortened, the transistor is likely to be affected by some kinds of adverse effects, which are collectively referred to as short-channel effects. For example, a phenomenon is known in which hot carriers accelerated by a strong electric field between a source and a drain are injected into and accumulated in a gate insulating film and the transistor characteristics with respect to a gate voltage are changed.

Therefore, it is desired that the transistors used in the driver circuit be configured to suppress hot-carrier degradation.

Thus, an object of one embodiment of the present invention is to provide a semiconductor device with high reliability. Another object is to provide a semiconductor device capable of inhibiting hot-carrier degradation. Another object is to provide a display device with a narrow bezel. Another object is to provide a display device with high reliability. Another object is to provide an electronic device including the above-described display device. Another object is to provide a novel semiconductor device, a novel display device, or a novel electronic device.

Note that the description of these objects does not preclude the existence of other objects. One embodiment of the present invention does not necessarily achieve all of these objects. Other objects can be derived from the description of the specification, the drawings, and the claims.

One embodiment of the present invention relates to a semiconductor device with high reliability. One embodiment of the present invention relates to a display device including the semiconductor device.

One embodiment of the present invention is a semiconductor device including a first switch and a second switch; the first switch includes first to third transistors; a drain of the first transistor is electrically connected to a high potential power supply line; a source of the first transistor is electrically connected to a drain of the second transistor; the drain of the second transistor is electrically connected to a gate and a drain of the third transistor; a source of the second transistor is electrically connected to a source of the third transistor; a gate of the first transistor is electrically connected to a gate of the second transistor; the second switch includes fourth to sixth transistors; a source of the fourth transistor is electrically connected to a low potential power supply line; a drain of the fourth transistor is electrically connected to a source of the fifth transistor; the source of the fifth transistor is electrically connected to a source of the sixth transistor; a drain of the fifth transistor is electrically connected to a gate and a drain of the sixth transistor; a gate of the fourth transistor is electrically connected to a gate of the fifth transistor; and the source of the second transistor and the drain of the fifth transistor are electrically connected to each other.

In the semiconductor device, the third transistor can include a first back gate; the sixth transistor can include a second back gate; the first back gate can be electrically connected to the source of the second transistor; and the second back gate can be electrically connected to the source of the fourth transistor.

In the semiconductor device, it is preferable that each of the first to sixth transistors contain a metal oxide in a semiconductor layer and be provided with a channel formation region along a side surface of an insulating layer.

Another embodiment of the present invention is a semiconductor device including a first switch and a second switch; the first switch includes first to seventh transistors; a drain of the first transistor is electrically connected to a high potential power supply line; a source of the first transistor is electrically connected to a drain of the second transistor and a gate and a drain of the fifth transistor; a source of the second transistor is electrically connected to a drain of the third transistor, a source of the fifth transistor, and a gate and a drain of the sixth transistor; a source of the third transistor is electrically connected to a drain of the fourth transistor, a source of the sixth transistor, and a gate and a drain of the seventh transistor; a source of the fourth transistor is electrically connected to a source of the seventh transistor; gates of the first to fourth transistors and the gates of the fifth to seventh transistors are electrically connected to each other; the second switch includes eighth to fourteenth transistors; a source of the eighth transistor is electrically connected to a low potential power supply line; a drain of the eighth transistor is electrically connected to a source of the ninth transistor and a source of the twelfth transistor; a drain of the ninth transistor is electrically connected to a source of the tenth transistor, a gate and a drain of the twelfth transistor, and a source of the thirteenth transistor; a drain of the tenth transistor is electrically connected to a source of the eleventh transistor, a gate and a drain of the thirteenth transistor, and a source of the fourteenth transistor; a drain of the eleventh transistor is electrically connected to a gate and a drain of the fourteenth transistor; gates of the eighth to eleventh transistors and the gates of the twelfth to fourteenth transistors are electrically connected to each other; and the source of the fourth transistor and the drain of the eleventh transistor are electrically connected to each other.

In the semiconductor device, the fifth transistor can include a first back gate; the sixth transistor can include a second back gate; the seventh transistor can include a third back gate; the twelfth transistor can include a fourth back gate; the thirteenth transistor can include a fifth back gate; the fourteenth transistor can include a sixth back gate; the first back gate can be electrically connected to the source of the third transistor; the second back gate and the third back gate can be electrically connected to the source of the fourth transistor; the fourth back gate can be electrically connected to the source of the eighth transistor; the fifth back gate can be electrically connected to the source of the ninth transistor; and the sixth back gate can be electrically connected to the source of the tenth transistor.

In the semiconductor device, the fifth transistor includes a first back gate; the sixth transistor can include a second back gate; the seventh transistor can include a third back gate; the twelfth transistor can include a fourth back gate; the thirteenth transistor can include a fifth back gate; the fourteenth transistor can include a sixth back gate; the first to third back gates can be electrically connected to the source of the fourth transistor; and the fourth to sixth back gates can be electrically connected to the source of the eighth transistor.

In the semiconductor device, it is preferable that each of the first to fourteenth transistors contain a metal oxide in a semiconductor layer and be provided with a channel formation region along a side surface of an insulating layer.

A display device including any one of the semiconductor devices in a pixel driver circuit and an electronic device including the display device and a speaker are also embodiments of the present invention.

According to one embodiment of the present invention, a highly reliable semiconductor device can be provided. A semiconductor device capable of inhibiting hot-carrier degradation can be provided. A display device with a narrow bezel can be provided. A display device including a driver circuit having a monolithic structure can be provided. A highly reliable display device can be provided. An electronic device including the above-described display device can be provided. A novel semiconductor device, a novel display device, or a novel electronic device can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

In the accompanying drawings:

FIGS. 1A to 1C are circuit diagrams illustrating a semiconductor device;

FIGS. 2A to 2D are diagrams illustrating operations of a conventional semiconductor device;

FIGS. 3A to 3D are diagrams illustrating operations of a semiconductor device;

FIGS. 4A and 4B are circuit diagrams illustrating a semiconductor device;

FIGS. 5A and 5B are diagrams illustrating operations of a semiconductor device;

FIGS. 6A and 6B are diagrams illustrating operations of a semiconductor device;

FIGS. 7A and 7B are circuit diagrams illustrating a semiconductor device;

FIGS. 8A and 8B are diagrams illustrating operations of a semiconductor device;

FIGS. 9A and 9B are diagrams illustrating operations of a semiconductor device;

FIG. 10 is a graph showing a shift in a threshold voltage of a transistor;

FIG. 11 is a graph showing shifts in threshold voltages of transistors;

FIG. 12A is a circuit diagram illustrating a semiconductor device, and FIG. 12B is a block diagram illustrating the semiconductor device;

FIG. 13A is a diagram illustrating an operation of a semiconductor device, and FIG. 13B is a circuit diagram illustrating the semiconductor device;

FIGS. 14A and 14B are diagrams illustrating operations of a semiconductor device;

FIG. 15 is a circuit diagram illustrating a shift register circuit;

FIG. 16A is a block diagram illustrating a sequential circuit, and FIGS. 16B and 16C are timing charts showing operations of a shift register circuit;

FIGS. 17A and 17B are diagrams illustrating a vertical transistor;

FIGS. 18A and 18B are diagrams illustrating a vertical transistor;

FIG. 19 is a diagram illustrating a vertical transistor;

FIG. 20 is a diagram illustrating a layout of a semiconductor device;

FIGS. 21A and 21B are cross-sectional views illustrating a semiconductor device;

FIGS. 22A to 22C are cross-sectional views illustrating a semiconductor device;

FIGS. 23A and 23B are cross-sectional views illustrating a semiconductor device;

FIG. 24A is a block diagram illustrating an example of a display device, and FIGS. 24B and 24C are circuit diagrams each illustrating an example of a pixel circuit;

FIGS. 25A to 25C are diagrams illustrating a structure example of a display panel;

FIGS. 26A and 26B are diagrams illustrating structure examples of display panels;

FIGS. 27A to 27F are diagrams illustrating structure examples of pixels;

FIGS. 28A to 28E are diagrams illustrating examples of electronic devices; and FIGS. 29A to 29G are diagrams illustrating examples of electronic devices.

### DETAILED DESCRIPTION OF THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments. Note that in structures of the invention described below, the same portions or portions having similar functions are denoted by the same reference numerals in different drawings, and the description thereof is not repeated in some cases. The same components are denoted by different hatching patterns in different drawings, or the hatching patterns are omitted in some cases.

Even in the case where a single component is illustrated in a circuit diagram, the component may be composed of a plurality of parts as long as there is no functional inconvenience. For example, in some cases, a plurality of transistors that operate as a switch are connected in series or in parallel. In some cases, capacitors are divided and arranged in a plurality of positions.

One conductor has a plurality of functions such as a wiring, an electrode, and a terminal in some cases. In this specification, a plurality of names are used for the same component in some cases. Even in the case where components are illustrated in a circuit diagram as if they were directly connected to each other, the components may actually be connected to each other through one or more conductors. In this specification, even such a structure is included in direct connection.

In this specification and the like, the term “electrically connected” includes the case where components are connected through an “object having any electric function”. There is no particular limitation on an “object having any electric function” as long as electric signals can be transmitted and received between components that are connected through the object. Examples of the “object having any electric function” are a switching element such as a transistor, a resistor, a coil, and an element with a variety of functions as well as an electrode and a wiring.

### Embodiment 1

One embodiment of the present invention is a semiconductor device having a function of inhibiting hot-carrier degradation of a transistor. The semiconductor device can be used as a component of a driver circuit of a display device, for example.

The semiconductor device includes a switch. The switch includes a plurality of transistors connected in series and a diode connected to a node between the transistors. An appropriate potential supplied from the diode to the node can lower the source-drain voltage (Vas) before the transistor is turned on, so that hot-carrier degradation can be inhibited.

A vertical transistor is preferably used as the transistor that is a component of the switch. The vertical transistor includes a channel formation region along a side surface of an opening portion provided in an insulator, and has a structure in which the channel length is easily shortened and the channel width is easily widened, so that the on-state current can be easily increased. The vertical transistor is suitable for a circuit that operates at high speed. In addition, since the vertical transistor can have a small occupied area, the use of the vertical transistor in the driver circuit of the display device brings an advantage of narrowing the bezel of the display device.

Note that in this specification and the like, series connection of transistors refers to connection between a drain of one of two adjacent transistors and a source of the other transistor. The conductivity type of the transistor used in the semiconductor device of one embodiment of the present invention is regarded as an n-type transistor; however, without limitation to this, a p-channel transistor can also be used by switching the levels of power sources to be supplied.

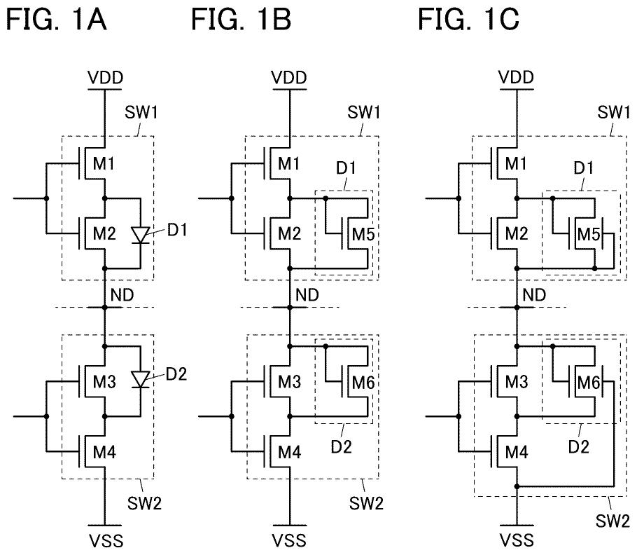

FIGS. 1A to 1C are circuit diagrams illustrating a semiconductor device of one embodiment of the present invention. Using FIG. 1A, a structure of the semiconductor device will be described. The semiconductor device includes a switch SW1 and a switch SW2. The switch SW1 and the switch SW2 are electrically connected to each other through a first conductor such as a wiring or an electrode.

In the semiconductor device, the first conductor is referred to as a node ND. The node ND is also electrically connected to a second conductor such as a wiring or an electrode included in a circuit where the semiconductor device is used. That is, in the circuit where the semiconductor device is used, the first conductor and the second conductor can be referred to as the node ND. The node ND can be brought into a floating state by an operation of a component connected to the node ND.

The switch SW1 is connected to a high potential power supply line and is turned on, whereby a high potential (VDD) can be supplied to the node ND. The switch SW2 is connected to a low potential power source and is turned on, whereby a low potential (VSS) can be supplied to the node ND. The semiconductor device repeats the switch between the state where the switch SW1 is in conduction and the switch SW2 is in non-conduction and the state where the switch SW1 is in non-conduction and the switch SW2 is in conduction, alternately in accordance with the operation of the applied circuit. That is, the potential of the node ND can be VDD or VSS in a steady state.

The switch SW1 and the switch SW2 each include a plurality of transistors connected in series and a diode. With the use of the plurality of transistors connected in series, leakage current can be reduced and the function of a switch can be enhanced.

Although the structure where each of the switch SW1 and the switch SW2 includes two transistors and one diode is described here, one embodiment of the present invention is not limited thereto, and a structure where each of the switch SW1 and the switch SW2 includes three or more transistors and two or more diodes may be employed. Description of these structures is given later.

In the switch SW1 and the switch SW2, the direction in which current flows when the switch SW1 or the switch SW2 is in a conduction state is always constant. Therefore, in the following description, when the transistor is in an on-state, a terminal on the high potential side is always referred to as a “drain”, and a terminal on the low potential side is always referred to as a “source”.

The switch SW1 includes a transistor M1 and a transistor M2 that are connected in series and a diode D1. A drain of the transistor M1 is electrically connected to a high potential power supply line. A source of the transistor M1 is electrically connected to a drain of the transistor M2 and an anode of the diode D1, and a source of the transistor M2 is electrically connected to a cathode of the diode D1. A gate of the transistor M1 is electrically connected to a gate of the transistor M2.

The switch SW2 includes a transistor M3 and a transistor M4 that are connected in series and a diode D2. A source of the transistor M4 is electrically connected to a low potential power supply line. A drain of the transistor M4 is electrically connected to a source of the transistor M3 and a cathode of the diode D2, and a drain of the transistor M3 is electrically connected to an anode of the diode D2. A gate of the transistor M3 is electrically connected to a gate of the transistor M4.

The switch SW1 and the switch SW2 each have the above structure, and the source of the transistor M2 and the drain of the transistor M3 are electrically connected to each other through the node ND.

In one embodiment of the present invention, hot-carrier degradation of a transistor is inhibited by the action of a diode in a switch. To describe the action, first, a structure and an operation of a conventional semiconductor device that does not include a diode will be described.

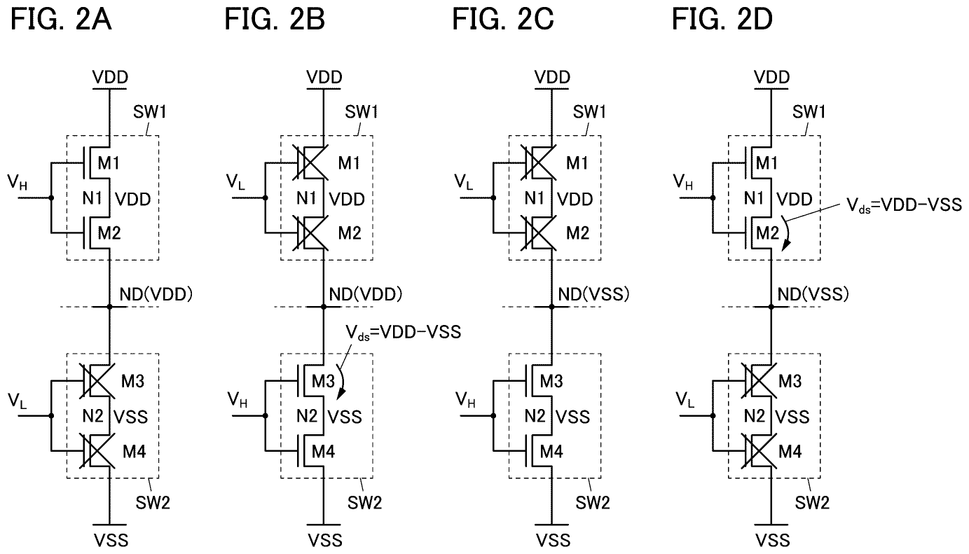

FIG. 2A is a circuit diagram illustrating an example of a conventional semiconductor device, in which a diode is omitted from FIG. 1A.

FIG. 2A illustrates a state where a potential at which a transistor is turned on and that is a high potential (V_{H}) higher than VDD, is supplied to the gates of the transistor M1 and the transistor M2, and a low potential (V_{L}) at which a transistor is turned off is supplied to the gates of the transistor M3 and the transistor M4. That is, the switch SW1 is in a conduction state and the switch SW2 is in a non-conduction state. The operation is described in such a manner that this steady state is a first state and a steady state where the switch SW1 is in a non-conduction state and the switch SW2 is in a conduction state is a second state.

In the first state, since the switch SW1 is in a conduction state and the switch SW2 is in a non-conduction state, the potential of the node ND is a high potential (VDD). At this time, in the switch SW1, the potential of a node N1 between the transistor M1 and the transistor M2 is also VDD. In the switch SW2, the potential of a node N2 between the transistor M3 and the transistor M4 is VSS.

In the state before the first state (the second state), when the transistor M3 and the transistor M4 are in an on state, the potentials of the node ND and the node N2 are each at a low potential (VSS). Thus, when the second state is changed into the first state (the transistor M3 and the transistor M4 are in an off state), VSS is retained in the node N2.

Next, a transition period from the first state to the second state is described with reference to FIG. 2B. FIG. 2B illustrates a state right after the switch SW2 is turned on.

First, the switch SW1 is turned off, and then the switch SW2 is turned on. When a high potential (V_{H}) is supplied to the gate of the transistor M3, the potential of the node ND is VDD and the potential of the node N2 is VSS. Accordingly, the source-drain voltage (V_{ds}) of the transistor M3 becomes VDD-VSS. VDD-VSS is a relatively large potential difference generated in the circuit, and current starts to flow in the transistor M3 when its V_{ds} is high. Therefore, hot carriers are likely to be generated in the transistor M3.

Current flows to the switch SW2 until the potential of the node ND decreases to VSS, whereby the switch SW2 is brought into a steady state. This state is the second state illustrated in FIG. 2C.

Next, a transition period from the second state to the first state is described with reference to FIG. 2D. FIG. 2D illustrates a state right after the switch SW1 is turned on.

First, the switch SW2 is turned off, and then the switch SW1 is turned on. When a high potential (VR) is supplied to the gate of the transistor M2, the potential of the node ND is VSS and the potential of the node N1 is VDD. Thus, the source-drain voltage (V_{ds}) of the transistor M2 is VDD-VSS, and current starts to flow when its V_{ds} is high. Therefore, hot carriers are likely to be generated in the transistor M2.

Current flows to the switch SW1 until the potential of the node ND increases to VDD, whereby the switch SW1 is brought into a steady state. This state is the first state illustrated in FIG. 2A.

As described above, the semiconductor device repeats the switch between the state where the switch SW1 is in conduction and the switch SW2 is in non-conduction and the state where the switch SW1 is in non-conduction and the switch SW2 is in conduction, alternately. Thus, in the transistor M2 and the transistor M3, the injection of the generated hot carrier to a gate insulating film is repeated, which causes hot-carrier degradation in which the threshold voltage increases.

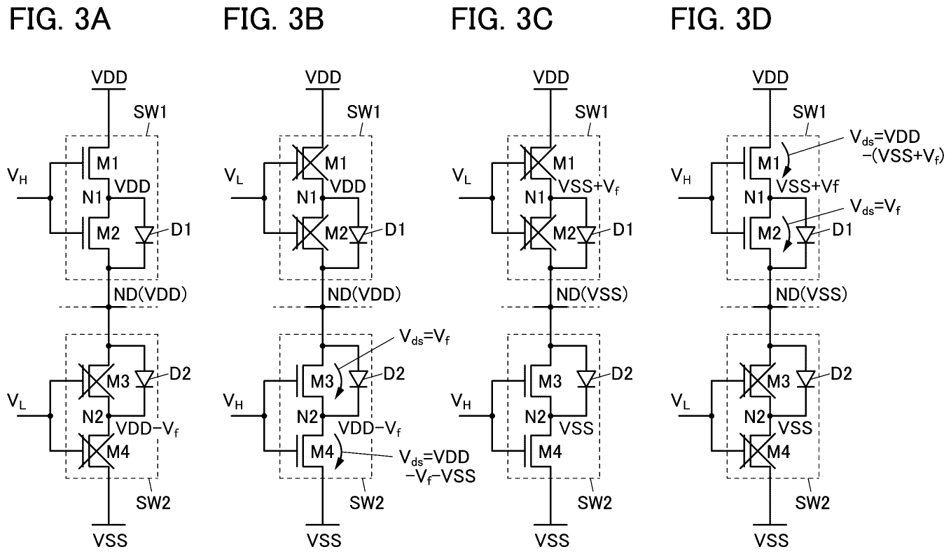

FIGS. 3A to 3D are diagrams illustrating operations of the semiconductor device of one embodiment of the present invention illustrated in FIG. 1A. The semiconductor device repeats the switch between the state where the switch SW1 is in conduction and the switch SW2 is in non-conduction and the state where the switch SW1 is in non-conduction and the switch SW2 is in conduction, alternately.

FIG. 3A illustrates a state where a high potential (V_{H}) at which a transistor is turned on is supplied to the gates of the transistor M1 and the transistor M2 and a low potential (V_{L}) at which a transistor is turned off is supplied to the gates of the transistor M3 and the transistor M4. That is, the switch SW1 is in a conduction state and the switch SW2 is in a non-conduction state. The operation is described in such a manner that this steady state is the first state, and a steady state where the switch SW1 is in a non-conduction state and the switch SW2 is in a conduction state is a second state.

In the first state, since the switch SW1 is in a conduction state and the switch SW2 is in a non-conduction state, the potential of the node ND is a high potential (VDD). In the switch SW1, the potential of the node N1 between the transistor M1 and the transistor M2 is also VDD.

In the switch SW2, in the state before the first state (the second state), when the transistor M3 and the transistor M4 are in an on state, the potentials of the node ND and the node N2 are each at a low potential (VSS). Thus, when the transistor M3 and the transistor M4 are in an off state, VSS is retained in the node N2.

However, in the process in which the potential of the node ND increases to VDD, current starts to flow in the diode D2 when the potential difference between the node ND and the node N2 reaches the forward voltage (Vf) of the diode D2. Then, when the potential of the node ND increases to VDD, the potential of the node N2 increases to VDD−V_{f}. That is, in the first state, the switch SW2 is in a non-conduction state, and the potential of the node N2 is VDD−Vf.

Next, a transition period from the first state to the second state is described with reference to FIG. 3B. FIG. 3B illustrates a state right after the switch SW2 is turned on.

First, the switch SW1 is turned off, and then the switch SW2 is turned on. When a high potential (VA) is supplied to the gates of the transistors M3 and M4, the potential of the node ND is VDD and the potential of the node N2 is VDD−V_{f}. Thus, the source-drain voltage (V_{ds}) of the transistor M3 becomes VDD−(VDD−V_{f})=V_{f}, and current starts to flow when its V_{ds} is relatively low. Thus, hot carriers are less likely to be generated in the transistor M3.

In addition, V_{ds} of the transistor M4 becomes VDD−V_{f} VSS, which is a value smaller than VDD−VSS, and it can be said that generation of hot carriers can be reduced more than that in a conventional semiconductor device.

Current flows to the switch SW2 until the potential of the node ND decreases to VSS, whereby the switch SW2 is in a steady state. This state is the second state illustrated in FIG. 3C.

In the switch SW1, when the transistor M1 and the transistor M2 are in an on state in the first state, the node ND and the node N1 are each a high potential (VDD). Thus, when the transistor M1 and the transistor M2 are in an off state, VDD is retained in the node N1.

However, in the process in which the potential of the node ND decreases to VSS, current starts to flow in the diode D1 when the potential difference between the node N1 and the node ND reaches the forward voltage (V_{f}) of the diode D1. Then, when the potential of the node ND decreases to VSS, the potential of the node N1 decreases to VSS+V_{f}. That is, in the second state, the switch SW1 is in a non-conduction state, and the potential of the node N1 is VSS+V_{f}.

Next, a transition period from the second state to the first state is described with reference to FIG. 3D. FIG. 3D illustrates a state right after the switch SW1 is turned on.

First, the switch SW2 is turned off, and then the switch SW1 is turned on. When a high potential (V_{H}) is supplied to the gate of the transistor M2, the potential of the node ND is VSS and the potential of the node N1 is VSS+V_{f}. Thus, the source-drain voltage (V_{ds}) of the transistor M2 becomes VSS+V_{f}-VSS=V_{f}, and current starts to flow when its V_{ds} is relatively low. Thus, hot carriers are less likely to be generated in the transistor M2.

In addition, V_{ds} of the transistor M1 becomes VDD−(VSS+V_{f}), which is a value smaller than VDD−VSS, and it can be said that generation of hot carriers can be reduced more than that in a conventional semiconductor device.

Current flows to the switch SW1 until the potential of the node ND increases to VDD, whereby the switch SW1 is brought into a steady state. This state is the first state illustrated in FIG. 3A.

As described above, when a diode is provided in the switch, V_{ds} of the transistor can be reduced. Thus, current starts to flow through a transistor when its V_{ds} is relatively low. In other words, generation of hot carriers can be suppressed and deterioration of the transistor can be prevented.

Note that in FIG. 1A and FIGS. 3A to 3D, the diode D1 and the diode D2 in the circuit diagram are denoted by diode symbols. That is, a pn junction diode, a pin junction diode, or the like can be used as each of the diode D1 and the diode D2.

However, in the case where the diode cannot be formed in the same manufacturing process as the transistor, the number of manufacturing processes is increased. Therefore, as illustrated in FIG. 1B, a diode-connected transistor in which a gate and a drain are electrically connected to each other is preferably used as the diode D1 and the diode D2.

The switch SW1 illustrated in FIG. 1B has a structure in which a diode-connected transistor M5 is used as the diode D1, and components are connected as follows. The drain of the transistor M1 is electrically connected to a high potential power supply line. The source of the transistor M1 is electrically connected to the drain of the transistor M2 and a gate and a drain of the transistor M5 The source of the transistor M2 is electrically connected to a source of the transistor M5. The gate of the transistor M1 is electrically connected to the gate of the transistor M2.

The switch SW2 illustrated in FIG. 1B has a structure in which a diode-connected transistor M6 is used as the diode D2, and components are connected as follows. The source of the transistor M4 is electrically connected to a low potential power supply line. The drain of the transistor M4 is electrically connected to the source of the transistor M3 and a source of the transistor M6. The drain of the transistor M3 is electrically connected to a gate and a drain of the transistor M6. The gate of the transistor M3 is electrically connected to the gate of the transistor M4.

The circuit in FIG. 1A and the circuit in FIG. 1B are equivalent to each other. In the case where a diode-connected transistor is used, the forward voltage (V_{f}) of the diode in the above description can be replaced with the threshold voltage (Vth) of the diode-connected transistor.

In the case where a diode-connected transistor is used as illustrated in FIG. 1C, the transistor may be provided with a back gate. By supplying an appropriate potential to the back gate, Vth of the transistor can be increased, and V_{ds} of the transistor M4 in FIG. 3B and V_{ds} of the transistor M1 in FIG. 3D can be reduced.

For example, as illustrated in FIG. 1C, a back gate of the transistor M5 can be electrically connected to the source of the transistor M2. A back gate of the transistor M6 can be electrically connected to the source of the transistor M4.

Note that, to increase the Vth of the transistor, a potential lower than the source potential of the transistor is preferably supplied to the back gate. In the case where there is no appropriate potential supply source, the source potential may be supplied to the back gate. Supplying the source potential to the back gate can stabilize the transistor characteristics. Note that a potential supply source may be additionally provided to supply an appropriate potential to the back gates.

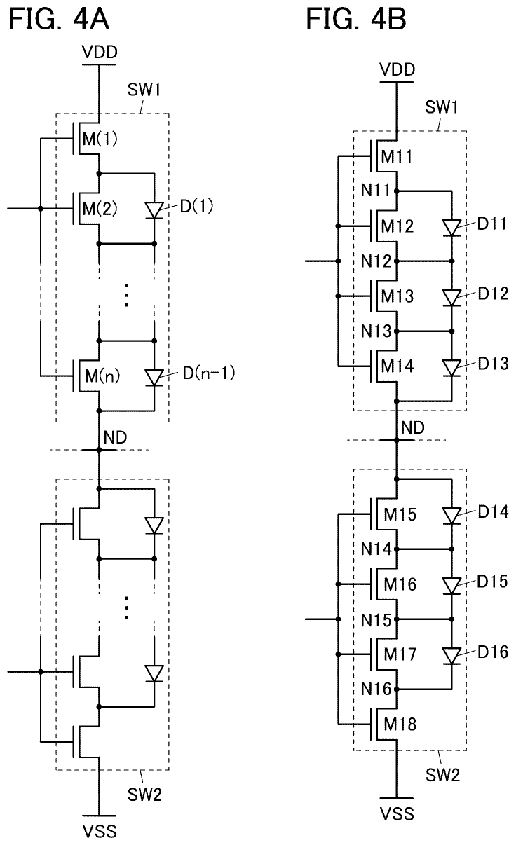

Next, an example of a semiconductor device in which the switch includes three or more transistors that are series-connected is described. FIG. 4A illustrates a mode in which the switch SW1 includes n transistors that are series-connected (n is an integer greater than or equal to 3) (transistors M1 to n) and n-1 diodes (diodes D1 to n-1). Note that the structure of the switch SW2 can be equivalent to that of the switch SW1; thus, the description thereof is omitted. In the switch, as the number of transistors connected in series increases, the channel resistance is increased; thus, leakage current can be reduced. Meanwhile, the on-state current is also reduced; thus, the number of transistors connected in series is set depending on the circuit to be used.

As illustrated in FIG. 4A, the transistors other than the transistors connected to the power supply lines are connected in parallel to the diodes, and the diodes D1 to n-1 are connected in series. Accordingly, the source potential of the transistor connected to the power supply line is strongly affected by the voltage drop of the diode.

That is, as illustrated in FIG. 3D, in the initial state of the transition period from the second state to the first state, V_{ds} of the transistor M1 is VDD−(VSS+V_{f}), whereas in the case where the number of the series-connected transistors is n, V_{ds} of the transistor M1 is VDD−(VSS+(n−1)×V_{f}). Accordingly, as the number of transistors connected in series increases, V_{ds} of the transistor connected to the power supply line can be lower. Note that V_{f} of the diodes connected in series are all equal to each other.

As a specific example, FIG. 4B illustrates an example in which four transistors that are series-connected are included in the switch.

The switch SW1 includes transistors M11 to M14 connected in series and diodes D11 to D13. A drain of the transistor M11 is electrically connected to a high potential power supply line. A source of the transistor M11 is electrically connected to a drain of the transistor M12 and an anode of the diode D11. A source of the transistor M12 is electrically connected to a drain of the transistor M13, a cathode of the diode D11, and an anode of the diode D12. A source of the transistor M13 is electrically connected to a drain of the transistor M14, a cathode of the diode D12, and an anode of the diode D13. A source of the transistor M14 is electrically connected to a cathode of the diode D13. Gates of the transistors M11 to M14 are electrically connected to each other.

Here, a node between the transistor M11 and the transistor M12 is referred to as a node N11. A node between the transistor M12 and the transistor M13 is referred to as a node N12. A node between the transistor M13 and the transistor M14 is referred to as a node N13.

The switch SW2 includes transistors M15 to M18 that are connected in series and diodes D14 to D16. A source of the transistor M18 is electrically connected to a low potential power supply line. A drain of the transistor M18 is electrically connected to a source of the transistor M17 and a cathode of the diode D16. A drain of the transistor M17 is electrically connected to a source of the transistor M16, an anode of the diode D16, and a cathode of the diode D15. A drain of the transistor M16 is electrically connected to a source of the transistor M15, an anode of the diode D15, and a cathode of the diode D14. A drain of the transistor M15 is electrically connected to an anode of the diode D14. Gates of the transistors M15 to M18 are electrically connected to each other.

Here, a node between the transistor M15 and the transistor M16 is referred to as a node N14. A node between the transistor M16 and the transistor M17 is referred to as a node N15. A node between the transistor M17 and the transistor M18 is referred to as a node N16.

The switch SW1 and the switch SW2 have the above structure, and the source of the transistor M14 and the drain of the transistor M15 are electrically connected to each other through the node ND.

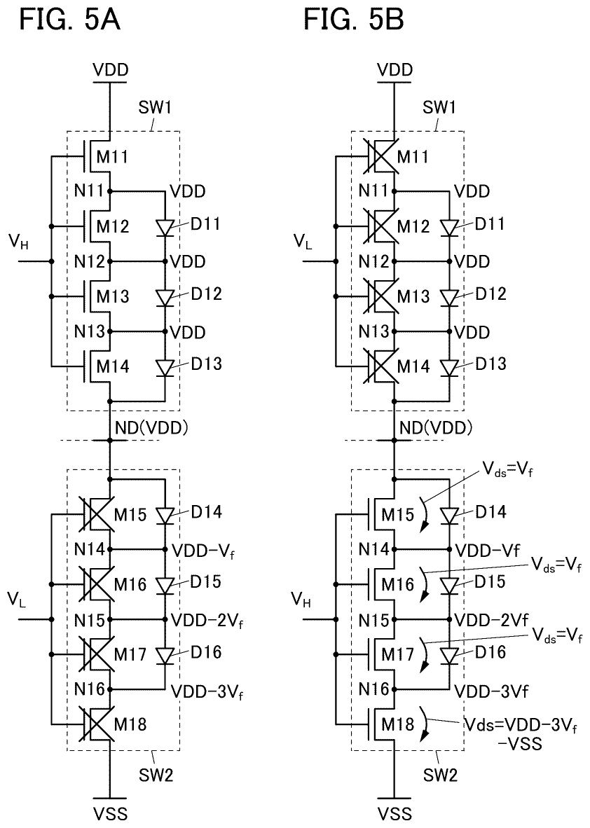

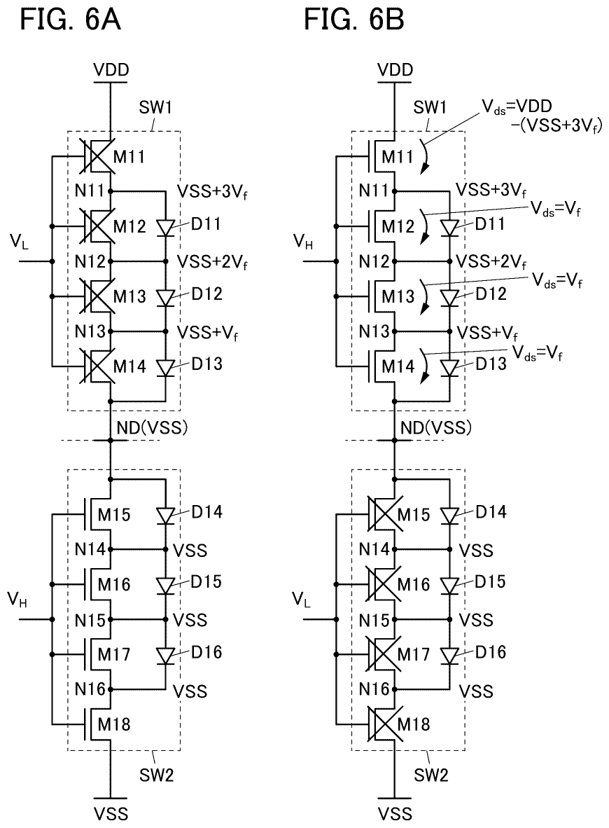

Next, the operation of the semiconductor device illustrated in FIG. 4B is described with reference to FIGS. 5A and 5B and FIGS. 6A and 6B.

FIG. 5A illustrates a state where a high potential (V_{H}) at which transistors are turned on is supplied to the gates of the transistors M11 to M14 and a low potential (V_{L}) at which transistors are turned off is supplied to the gates of the transistors M15 to M18. That is, the switch SW1 is in a conduction state and the switch SW2 is in a non-conduction state. The operation is described in such a manner that this steady state is the first state, and a steady state where the switch SW1 is in a non-conduction state and the switch SW2 is in a conduction state is a second state.

In the first state, since the switch SW1 is in a conduction state and the switch SW2 is in a non-conduction state, the potential of the node ND is a high potential (VDD). In the switch SW1, the potentials of the nodes N11 to N13 are also VDD.

In the switch SW2, when the transistors M15 to M18 are in an on state in a state before the first state (the second state), the potentials of the node ND and the nodes N14 to N16 are each at a low potential (VSS). Thus, when the transistors M15 to M18 are in an off state, VSS is retained in the nodes N14 to N16.

However, in the process in which the potential of the node ND increases to VDD, current starts to flow in the diode D14 when the potential difference between the node ND and the node N14 reaches the forward voltage (V_{f}) of the diode D14. When the potential difference between the node N14 and the node N15 reaches the forward voltage (V_{f}) of the diode D15, current starts to flow in the diode D15. When the potential difference between the node N15 and the node N16 reaches the forward voltage (V_{f}) of the diode D16, current starts to flow in the diode D16.

Then, when the potential of the node ND increases to VDD, the potential of the node N14 increases to VDD−V_{f}. When the potential of the node N14 increases to VDD−V_{f}, the potential of the node N15 increases to VDD−2V_{f}. When the potential of the node N15 increases to VDD−2V_{f}, the potential of the node N16 increases to VDD−3V_{f}.

That is, in the first state, the switch SW2 is in a non-conduction state; the potential of the node N14 is VDD−V_{f}, the potential of the node N15 is VDD−2V_{f}, and the potential of the node N16 is VDD−3V_{f}.

Next, a transition period from the first state to the second state is described with reference to FIG. 5B. FIG. 5B illustrates a state right after the switch SW2 is turned on.

First, the switch SW1 is turned off, and then the switch SW2 is turned on. When a high potential (V_{H}) is supplied to the gates of the transistors M15 to M18, the potential of the node ND is VDD and the potential of the node N14 is VDD−V_{f}. Accordingly, the source-drain voltage (V_{ds}) of the transistor M15 is VDD−(VDD−V_{f})=V_{f}.

The potential of the node N14 is VDD−V_{f}, and the potential of the node N15 is VDD−2V_{f}. Accordingly, the source-drain voltage (V_{ds}) of the transistor M16 is VDD−V_{f} (VDD−2V_{f})=V.

The potential of the node N15 is VDD−2V_{f}, and the potential of the node N16 is VDD−3V_{f}. Thus, the source-drain voltage (V_{ds}) of the transistor M17 is VDD−2V_{f}−(VDD−3V_{f})=V_{f}.

Thus, current starts to flow through the transistors M15 to M17 when its V_{ds} is relatively low. Thus, hot carriers are less likely to be generated in the transistors M15 to M17.

In addition, V_{ds} of the transistor M18 is VDD−3V_{f}−VSS, which is a value smaller than VDD−VSS, and it can be said that generation of hot carriers can be reduced more than that in a conventional semiconductor device. Furthermore, when the number of transistors connected in series is increased, V_{ds} becomes lower as compared with that in FIG. 3B.

Current flows to the switch SW2 until the potential of the node ND decreases to VSS, whereby the switch SW2 is in a steady state. This state is the second state illustrated in FIG. 6A.

In the switch SW1, when the transistors M11 to M14 are in an on state in the first state, the potentials of the node ND and the node N2 are each a high potential (VDD). Thus, when the transistors M11 to M14 are in an off state, VDD is retained in the nodes N11 to N13.

However, in the process in which the potential of the node ND decreases to VSS, current starts to flow in the diode D13 when the potential difference between the node N13 and the node ND reaches the forward voltage (V_{f}) of the diode D13. When a potential difference between the node N13 and the node N12 reaches the forward voltage (V_{f}) of the diode D12, current starts to flow through the diode D12. When a potential difference between the node N12 and the node N11 reaches the forward voltage (V_{f}) of the diode D11, current starts to flow in the diode D11.

Then, when the potential of the node ND decreases to VSS, the potential of the node N13 decreases to VSS+V_{f}. When the potential of the node N13 decreases to VSS+V_{f}, the potential of the node N12 decreases to VSS+2V_{f}. When the potential of the node N12 decreases to VSS+2V_{f}, the potential of the node N11 decreases to VSS+3V_{f}.

That is, in the second state, the switch SW1 is in a non-conduction state; the potential of the node N13 is VSS+V_{f}, the potential of the node N12 is VSS+2V_{f}, and the potential of the node N11 is VSS+3V_{f}.

Next, a transition period from the second state to the first state is described with reference to FIG. 6B. FIG. 6B illustrates a state right after the switch SW1 is turned on.

First, the switch SW2 is turned off, and then the switch SW1 is turned on. When a high potential (V_{H}) is supplied to the gates of the transistors M11 to M14, the potential of the node ND is VSS and the potential of the node N13 is VSS+V_{f}. Accordingly, the source-drain voltage (V_{ds}) of the transistor M14 is VSS+V_{f}−VSS=V_{f}.

The potential of the node N13 is VSS+V, and the potential of the node N12 is VSS+2V_{f}. Accordingly, the source-drain voltage (V_{ds}) of the transistor M13 is VSS+2V_{f}−(VSS+V_{f})=V_{f}.

The potential of the node N12 is VSS+2V_{f}, and the potential of the node N11 is VSS+3V_{f}. Accordingly, the source-drain voltage (V_{ds}) of the transistor M12 is VSS+3V_{f} (VSS+2V_{f})=V_{f}.

Thus, current starts to flow through the transistors M12 to M14 when its V_{ds} is relatively low. Therefore, hot carriers are less likely to be generated in the transistors M12 to M14.

In addition, V_{ds} of the transistor M11 is VDD−(VSS+3V_{f}), which is a value smaller than VDD−VSS, and it can be said that generation of hot carriers can be reduced more than that in a conventional semiconductor device. Furthermore, when the number of transistors connected in series is increased, V_{ds} becomes lower as compared with that in FIG. 3D.

Current flows to the switch SW1 until the potential of the node ND increases to VDD, whereby the switch SW1 is brought into a steady state. This state is the first state illustrated in FIG. 5A.

As described above, when the diode is provided in the switch, current can be started to flow through the transistor from the state when its V_{ds} is relatively low. Therefore, generation of hot carriers can be suppressed and deterioration of the transistor can be prevented.

Note that in the semiconductor device illustrated in FIG. 4B, a diode-connected transistor can be used as a diode, as in the example illustrated in FIG. 1B.

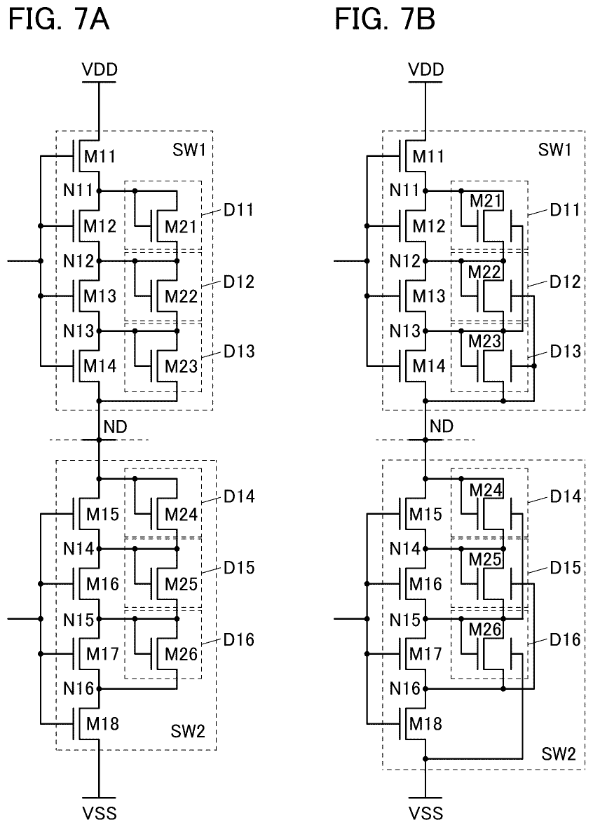

As illustrated in FIG. 7A, a diode-connected transistor M21 can be used as the diode D11 in the switch SW1. A diode-connected transistor M22 can be used as the diode D12. A diode-connected transistor M23 can be used as the diode D13.

Components of the switch SW1 are connected as follows. The drain of the transistor M11 is electrically connected to a high potential power supply line. The source of the transistor M11 is electrically connected to the drain of the transistor M12 and a gate and a drain of the transistor M21. The source of the transistor M12 is electrically connected to the drain of the transistor M13, a source of the transistor M21, and a gate and a drain of the transistor M22. The source of the transistor M13 is electrically connected to the drain of the transistor M14, a source of the transistor M22, and a gate and a drain of the transistor M23. The source of the transistor M14 is electrically connected to a source of the transistor M23. The gates of the transistors M11 to M14 are electrically connected to each other.

In the switch SW2, a diode-connected transistor M24 can be used as the diode D14. A diode-connected transistor M25 can be used as the diode D15. A diode-connected transistor M26 can be used as the diode D16.

Components of the switch SW2 are connected as follows. The source of the transistor M18 is electrically connected to a low potential power supply line. The drain of the transistor M18 is electrically connected to the source of the transistor M17 and a source of the transistor M26. The drain of the transistor M17 is electrically connected to the source of the transistor M16, a gate and a drain of the transistor M26, and a source of the transistor M25. The drain of the transistor M16 is electrically connected to the source of the transistor M15, a gate and a drain of the transistor M25, and a source of the transistor M24. The drain of the transistor M15 is electrically connected to a gate and a drain of the transistor M24. The gates of the transistors M15 to M18 are electrically connected to each other.

The circuit in FIG. 4B and the circuit in FIG. 7A are equivalent to each other. In the case where a diode-connected transistor is used, the forward voltage (V_{f}) of the diode in the above description can be replaced with the threshold voltage (Vth) of the diode-connected transistor.

In the case where a diode-connected transistor is used as illustrated in FIG. 7B, a back gate may be provided for the transistor. By supplying an appropriate potential to the back gate, Vth of the transistor can be increased.

For example, a back gate of the transistor M21 can be electrically connected to the source of the transistor M22. A back gate of the transistor M22 and a back gate of the transistor M23 can be electrically connected to the source of the transistor M23.

A back gate of the transistor M24 can be electrically connected to the source of the transistor M25. A back gate of the transistor M25 can be electrically connected to the source of the transistor M26. A back gate of the transistor M26 can be electrically connected to a low potential power supply line.

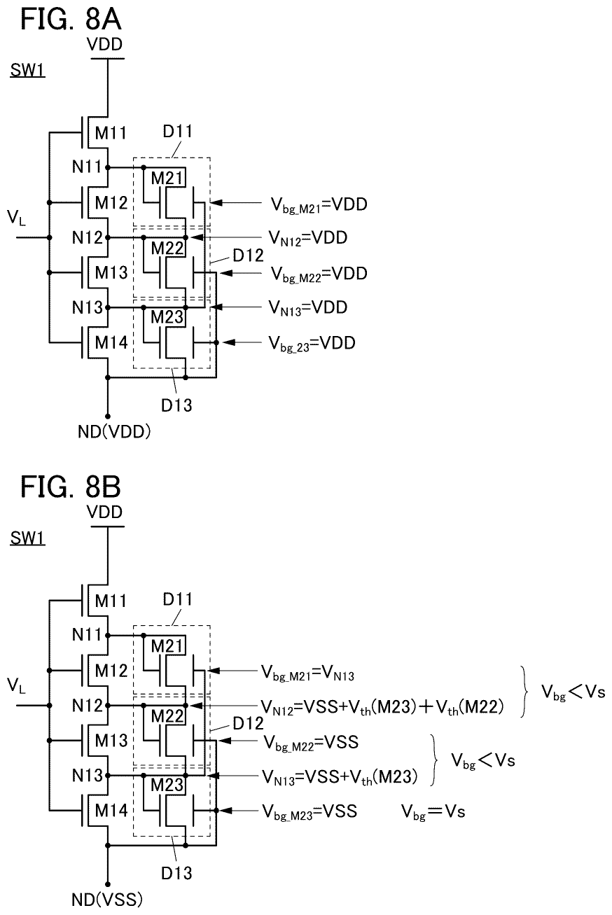

FIGS. 8A and 8B are diagrams illustrating potentials applied to the back gates before the switch SW1 is turned on.

FIG. 8A corresponds to the state in FIG. 5B and illustrates the potentials of the nodes N12 and N13 (V_{N12} and V_{N13}) of the switch SW1 and the back gate potentials of the transistors M21, M22, and M23 (V_{bg_M21}, V_{bg_M22}, and V_{bg_M23}) in a transition period from the first state to the second state (the potential of the node ND is in the VDD state right after the switch SW2 is turned on). At this time, the potentials of the back gates are all VDD.

FIG. 8B corresponds to the state in FIG. 6A and illustrates V_{N12}, V_{N13}, V_{bg_M21}, V_{bg_M22}, and V_{bg_M23} of the switch SW1 in the second state (a steady state where the potential of the node ND is decreased from VDD to VSS). Note that V_{th_}(the reference numeral of the transistor) in the following description shows the threshold voltage of the transistor.

Here, the source potential of the transistor M23 and V_{bg_M23} are each a potential of the node ND, that is, VSS. That is, the potential of the back gate (V_{bg}) is the same as the source potential (Vₛ) (V_{bg}=Vₛ).

The source potential of the transistor M22 is V_{N13}, that is, VSS+V_{th_M23}. V_{bg_M22} is the potential of the node ND, that is, VSS. That is, the potential of the back gate (V_{bg}) is lower than the source potential (Vₛ) (V_{bg}<Vₛ).

The source potential of the transistor M21 is V_{N12}, that is, VSS+V_{th_M23}+V_{th_M22}. The potential of the back gate is V_{N13}, that is, VSS+V_{th_M23}. That is, the potential of the back gate (V_{bg}) is lower than the source potential (Vₛ) (V_{bg}<Vₛ).

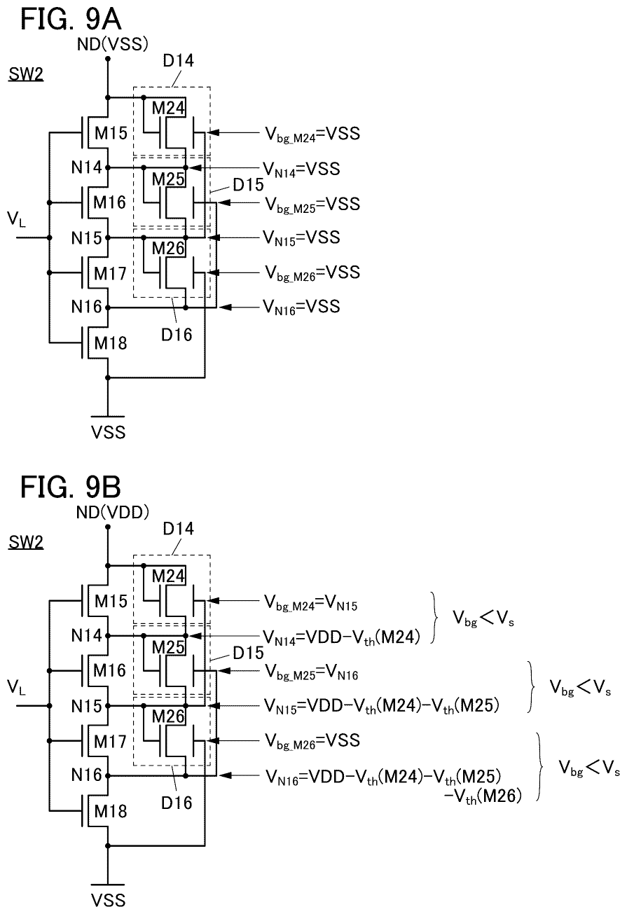

FIGS. 9A and 9B are diagrams illustrating potentials applied to the back gates before the switch SW2 is turned on.

FIG. 9A corresponds to the state in FIG. 6B and illustrates the potentials of the nodes N14, N15, and N16 (V_{N14}, V_{N15}, and V_{N16}) and the back gate potentials of the transistors M24, M25, and M26 (V_{bg_M24}, V_{bg_M25}, and V_{bg_M26}) of the switch SW2 in a transition period from the second state to the first state (the state where the potential of the node ND is VSS right after the switch SW1 is turned on). At this time, all the potentials of the back gates are VSS.

FIG. 9B corresponds to the state in FIG. 5A and illustrates V_{N14}, V_{N15}, V_{N16}, V_{bg_M24}, V_{bg_M25}, and V_{bg_M26} of the switch SW2 in the first state (a steady state where the potential of the node ND is increased from VSS to VDD).

Here, the source potential of the transistor M24 is V_{N14}, that is, VDD−V_{th_M24}. V_{bg_M24} is V_{N15}, that is, VDD−V_{th_M24}-V_{th_M25}. That is, the potential of the back gate (V_{bg}) is lower than the source potential (Vₛ) (V_{bg}<Vₛ).

The source potential of the transistor M25 is V_{N15}, that is, VDD−V_{th_M24}-V_{th_M25}. V_{bg_M25} is V_{N16}, that is, VDD−V_{th_M24}-V_{th_M25}-V_{th_M26}. That is, the potential of the back gate (V_{bg}) is lower than the source potential (Vₛ) (V_{bg}<Vₛ).

The source potential of the transistor M26 is V_{N16}, that is, VDD−V_{th_M24}-V_{th_M25}-V_{th_M26}. V_{bg_M26} is the potential of the node ND, that is, VSS. That is, the potential of the back gate (V_{bg}) is lower than the source potential (Vₛ) (V_{bg}<Vₛ).

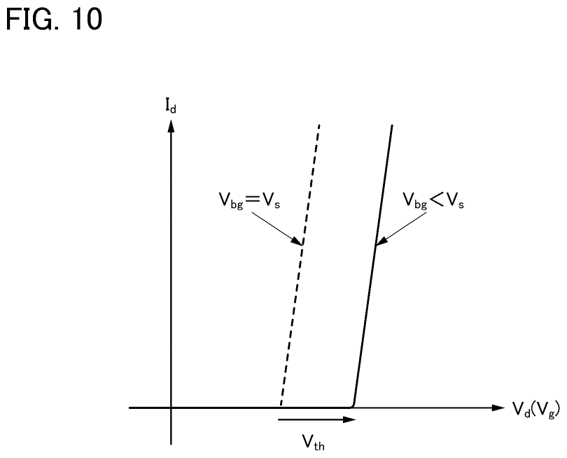

As described above, in the switch SW1 and the switch SW2, the potential of the back gate can be equal to the source potential (V_{bg}=Vₛ) or the potential of the back gate can be lower than the source potential (V_{bg}<Vₛ). In the case of V_{bg}<Vₛ, the potential of the back gate is negative with respect to the source potential, which contributes to inhibition of channel formation in an n-channel transistor. That is, the threshold voltage (Vₜₕ) can be shifted in the positive direction as in the I_{d}-V_{d} (V_{g}) characteristics of the diode-connected transistor illustrated in FIG. 10.

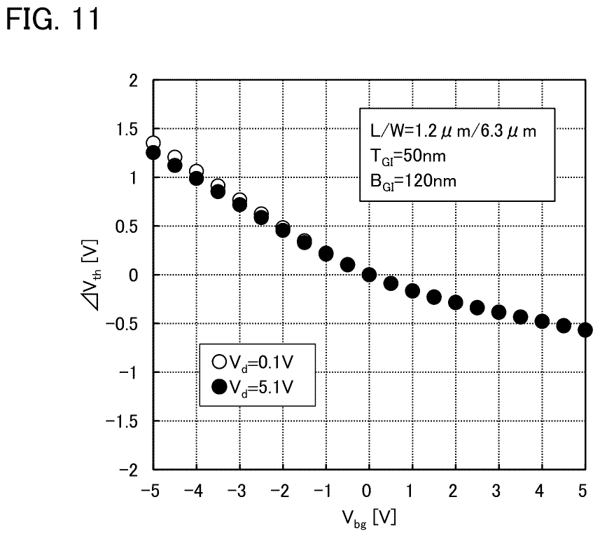

FIG. 11 is a diagram showing actually measured values of a change in the shift amount of Vₜₕ(ΔVₜₕ) in a vertical transistor (with a back gate) due to a back gate voltage (V_{bg}). The size of the vertical transistor is L/W=1.2 μm/6.3 μm (2 μmφ), the thickness of the gate insulating film on the front gate side (T_{Gt}) is 50 nm, and the thickness of the gate insulating film on the back gate side (B_{GH}) is 120 nm.

When the drain voltage (V_{d}) is set to 0.1 V and 5.1 V and V_{bg} is set to −5 V to +5 V, Vₜₕ is calculated from the I_{d}-V_{g} curve obtained by changing the voltage of the front gate (V_{g}) from −10 V to +10 V with each of V_{d} and V_{bg}.

Note that although the transistor from which the data is obtained is not a diode-connected transistor and different potentials are applied to the front gate and the drain, a difference due to V_{d} is small as illustrated in FIG. 11, which means that the Vₜₕ of the diode-connected transistor is substantially equal to the Vₜₕ of the measured transistor.

It is found from FIG. 11 that as a negative potential with a large absolute value is applied to V_{bg}, the shift amount of ΔVₜₕ increases in the positive direction. Since Vₜₕ of the transistor is approximately 0.5 V to 1 V, Vₜₕ of the transistor including a back gate is a value obtained by adding approximately 0.5 V to 1 V to the value in FIG. 11.

Here, rough estimation of V_{ds} in the semiconductor device of one embodiment of the present invention is described. The V_{ds} of the transistor M18 illustrated in the switch SW2 in FIG. 5B is VDD−3V_{f}−VSS, and in the case where a diode-connected transistor is used for the switch SW2, the V_{ds} of the transistor M18 is VDD−3Vₜₕ-VSS.

For example, when VDD is 15 V, VSS is 0 V, and Vₜₕ is 1 V, the V_{ds} of the transistor M18 is 12 V; however, when Vₜₕ is 2 V due to the action of the back gate, V_{ds} can be 9 V. In the case where V_{bg}=Vₛ, V_{ds} is not necessarily low; however, since the potential of V_{bg} can be determined, the characteristics of the transistor can be stabilized.

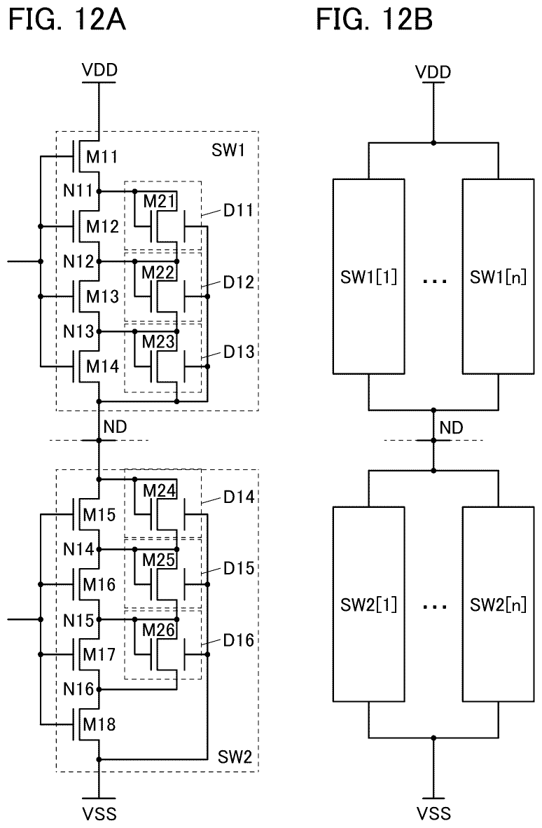

Note that as illustrated in FIG. 12A, the back gate may be connected to the node ND in all the diode-connected transistors of the switch SW1, and the back gate may be connected to the low potential power supply line in all the diode-connected transistors of the switch SW2. Even with such a structure, the transistors M21, M22, M24, M25, and M26 can be V_{bg}<Vₛ.

Each of the switch SW1 and the switch SW2 is not limited to one, and a plurality of switches SW1 and SW2 may be employed. For example, as illustrated in FIG. 12B, n switches SW1 and n switches SW2 (n is an integer greater than or equal to 2) can each be connected in parallel. When the plurality of switches SW1 and the plurality of switches SW2 are each connected in parallel in this manner, a reduction in on-state current due to series connection of transistors can be compensated for.

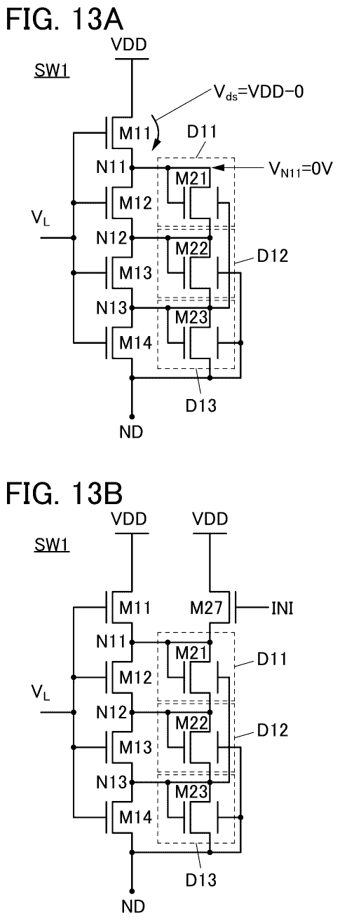

When the switch SW1 is electrically connected to the semiconductor device for the first time, hot carriers are generated in some cases. For example, when the potential of the node ND is indefinite and the potential of the node N11 (V_{N11}) is 0 V as illustrated in FIG. 13A, V_{ds} of the transistor M11 might be VDD−0, which is a relatively large value. In such a case, hot carriers are likely to be generated.

Thus, as illustrated in FIG. 13B, the switch SW1 may be provided with a transistor M27. A drain of the transistor M27 is electrically connected to a high potential power supply line, and a source of the transistor M27 is electrically connected to the gate and the drain of the transistor M21. A gate of the transistor M27 can be supplied with an initial reset signal (a signal INI) before the transistors M11 to M14 are turned on.

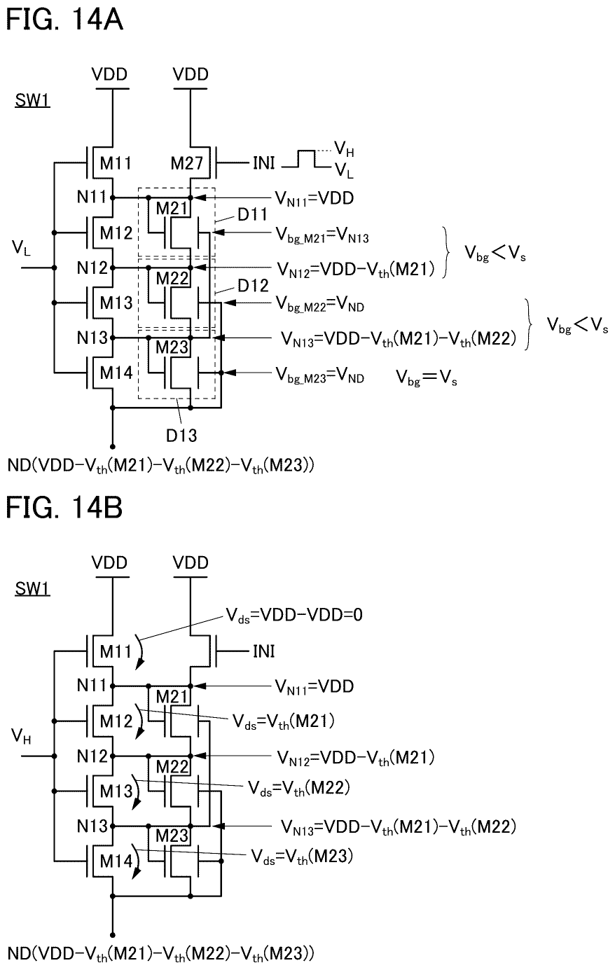

FIG. 14A shows the potentials of the nodes and the back gates after the signal INI is supplied. The signal INI is a signal for supplying V_{H} in a pulsed manner, and when V_{N11} becomes VDD, the transistor M21 is turned on and V_{N12} becomes VDD−Vₜₕ(M21). Furthermore, the transistors M22 and M23 are sequentially turned on, V_{N13} becomes VDD−Vₜₕ(M21)−Vₜₕ(M22), and VND becomes VDD−Vₜₕ(M21)−Vₜₕ(M22)−Vₜₕ(M23).

At this time, the source potential of the transistor M21 is V_{N12}, that is, VDD−V_{th_M21}. The potential of the back gate is V_{N13}, that is, VDD−Vₜₕ(M21)−Vₜₕ(M22). That is, the potential of the back gate (V_{bg}) is lower than the source potential (Vₛ) (V_{bg}<Vₛ).

The source potential of the transistor M22 is V_{N13}, that is, VDD−Vₜₕ(M21)−Vₜₕ(M22). V_{bg_M22} is the potential of the node ND, that is, VDD−Vₜₕ(M21)−Vₜₕ(M22)−Vₜₕ(M23). That is, the potential of the back gate (V_{bg}) is lower than the source potential (Vₛ) (V_{bg}<Vₛ).

The source potential of the transistor M23 and V_{bg_M23} are each a potential of the node ND, that is, VDD−Vₜₕ(M21)−Vₜₕ(M22)−Vₜₕ(M23). That is, the potential of the back gate (V_{bg}) is the same as the source potential (Vₛ) (V_{bg}=Vₛ).

As described above, even the case where the transistor M27 is provided in the switch SW1, the potential of the back gate of the diode-connected transistor can be equal to the source potential (V_{bg}=Vₛ) or the potential of the back gate can be lower than the source potential (V_{bg}<Vₛ).

As shown in FIG. 14B, right after the switch SW1 is turned on, V_{ds} of the transistor M11 is VDD−VDD=0; V_{ds} of the transistor M12 is VDD−(VDD−Vₜₕ(M21))=Vin (M21); V_{ds} of the transistor M13 is VDD−Vₜₕ(M21)-(VDD−Vₜₕ(M21)−Vₜₕ(M22))=Vₜₕ(M22); and V_{ds} of the transistor M14 is VDD−Vₜₕ(M21)−Vₜₕ(M22)-(VDD−Vₜₕ(M21)−Vₜₕ(M22)−Vin (M23))=Vₜₕ(M23). Thus, when the switch SW1 is turned on, V_{ds} can be lowered in all the transistors M11 to M14, so that generation of hot carriers can be inhibited.

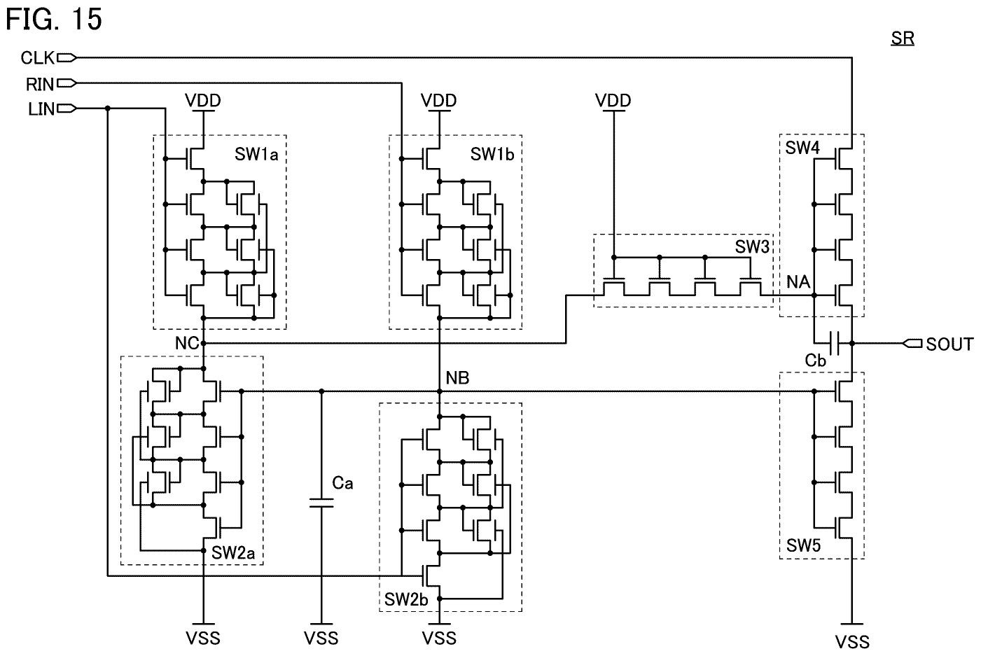

FIG. 15 is a circuit diagram illustrating an example in which the semiconductor device of one embodiment of the present invention is used in a shift register circuit. Here, an example in which the semiconductor device illustrated in FIG. 7B is used for a shift register circuit SR is illustrated.

The shift register circuit SR includes a switch SW1a and a switch SW1b as the switch SW1, and a switch SW2a and a switch SW2b as the switch SW2. The switch SW1a is electrically connected to the switch SW2a through a node NC. The switch SW1b is electrically connected to the switch SW2b through a node NB. The details of the node will be described later. The shift register circuit includes a switch SW3, a switch SW4, and a switch SW5 each including a plurality of transistors connected in series. The shift register circuit includes two capacitors (capacitors Ca and Cb).

Although FIG. 15 illustrates an example in which each of the switches SW3 to SW5 is provided with four transistors connected in series like the switch SW1a and the like, one embodiment of the present invention is not limited there to, and the number of transistors provided may be one or more. When the plurality of transistors are connected in series, leakage current can be reduced and a circuit operation can be stabilized.

In the following description, each of the switches is regarded as one transistor for simplicity, and gates of the plurality of transistors connected in series in each of the switches are referred to as gates of the switches. In each of the switches, a drain of a transistor, at an end of the plurality of transistors connected in series, to which a high potential is supplied is referred to as a drain of the switch, and a source of a transistor, at an end of the plurality of transistors, to which a low potential is supplied is referred to as a source of the switch. Note that the connection structure of the diode-connected transistors included in the switch SW1 and the switch SW2 is not described here.

A source of the switch SW1a is electrically connected to a drain of the switch SW2a and one of a source and a drain of the switch SW3. A gate of the switch SW2a is electrically connected to one electrode of the capacitor Ca, a source of the switch SW1b, a drain of the switch SW2b, and a gate of the switch SW5. The other of the source and the drain of the switch SW3 is electrically connected to a gate of the switch SW4 and one electrode of the capacitor Cb. One of a source and a drain of the switch SW4 is electrically connected to the other electrode of the capacitor Cb and a drain of the switch SW5.

A high potential power supply line is electrically connected to a drain of the switch SW1a, a drain of the switch SW1b, and a gate of the switch SW3. A low potential power supply line is electrically connected to a source of the switch SW2a, a source of the switch SW2b, a source of the switch SW5, and the other electrode of the capacitor Ca.

Gates of the switch SW1a and the switch SW2b function as signal input portions LIN. A gate of the switch SW1b functions as a signal input portion RIN. The other of the source and the drain of the switch SW4 functions as a clock signal input portion CLK. The one of a source and a drain of the switch SW4, the other electrode of the capacitor Cb, and the drain of the switch SW5 function as a signal output portion SOUT.

Here, a point (e.g., a wiring or an electrode) electrically connecting the other of the source and the drain of the switch SW3, the gate of the switch SW4, and the one electrode of the capacitor Cb is referred to as a node NA. A point (e.g., a wiring or an electrode) electrically connecting the gate of the switch SW2a, the one electrode of the capacitor Ca, the source of the switch SW1b, the drain of the switch SW2b, and the gate of the switch SW5 is referred to as the node NB. A point (e.g., a wiring or an electrode) electrically connecting the source of the switch SW1a, the drain of the switch SW2a, and the one of the source and the drain of the switch SW3 is referred to as the node NC.

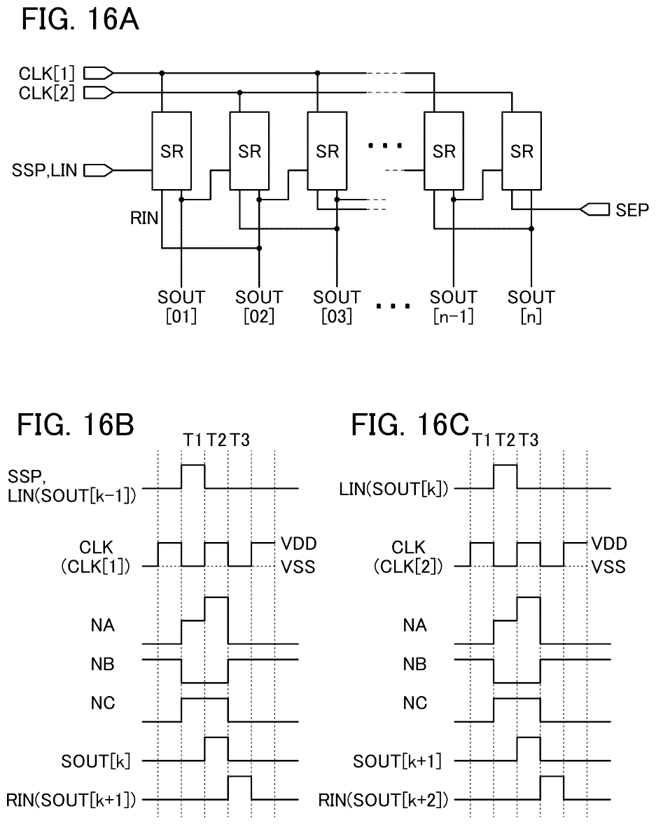

As illustrated in FIG. 16A, n stages (n is an integer greater than or equal to 2) of the shift register circuit SR are cascaded to each other, whereby a sequential circuit can be formed. A start pulse signal (SSP) is input to the signal input portion LIN of the shift register circuit SR in the first stage, and the signal output portion SOUT [01] is electrically connected to the signal input portion LIN of the shift register circuit in the second stage. The signal output portion SOUT [02] of the shift register circuit SR in the second stage is electrically connected to the signal input portion RIN of the shift register circuit SR in the first stage. An end pulse (SEP) is input to the signal input portion RIN of the n-th shift register circuit SR. Note that a dummy shift register circuit SR for generating SEP may be provided.

With such a structure, pulse signals can be sequentially output to the signal output portions SOUT[01] to [n], and can be used for a gate driver circuit for selecting a pixel of the display device or a driver circuit for a touch sensor. Furthermore, when used in combination with a latch circuit, an amplifier circuit, and the like, the shift register circuit can also be used as a source driver circuit that supplies data to a pixel.

Next, an operation of the sequential circuit illustrated in FIG. 16A used as a gate driver circuit is described. FIG. 16B is a timing chart showing the operation of the shift register circuit SR electrically connected to the gate line in the k-th row (k is an odd number less than or equal to n−1). FIG. 16C is a timing chart showing the operation of the shift register circuit SR electrically connected to the gate line in the k+1-th row.

As shown in FIG. 16A, the clock signal input in an odd-numbered stage is different from the clock signal input in an even-numbered stage; however, basic operation is substantially the same. Here, the operation of the shift register circuit SR electrically connected to the gate line in the k-th row is mainly described with reference to FIG. 16B.

Here, a signal input to the signal input portion LIN is referred to as a LIN signal, a signal input to the clock signal input portion CLK is referred to as a CLK signal, a signal input to the signal input portion RIN is referred to as a RIN signal, and a signal output from the signal output portion SOUT is referred to as a SOUT signal.

In a period T1, the LIN signal at a high-level potential is input to the gate of the switch SW1a from SPP or the gate line in the n−1-th row, the switch SW1a is turned on, the potential of the node NC becomes the high-level potential (VDD), and the node NA is precharged. At this time, current flows through the diode-connected transistor and V_{ds} of the series-connected transistor becomes low in the switch SW2a.

Furthermore, the LIN signal at a high-level potential is also input to the gate of the switch SW2b from SSP or the gate line in the n−1-th row, the switch SW2b is turned on, and the node NB is discharged to have the low-level potential. At this time, current flows through the diode-connected transistor and V_{ds} of the series-connected transistor becomes low in the switch SW1b.

The switch SW4 is turned on by precharge of the node NA, and the switch SW5 is turned off and the CLK signal is at a low-level potential (VSS) by discharge of the node NB; thus, the SOUT signal becomes at a low-level potential. A potential difference of VDD−VSS is charged in the capacitor Cb.

In a period T2, when the CLK signal is switched to have a high-level potential (VDD), the switch SW4 is turned on, the switch SW5 is turned off, and the SOUT signal becomes at a high-level potential.

In addition, as the gate line in the k-th row is charged, the potential of the node NA increases owing to capacitive coupling of the capacitor Cb and the gate voltage of the switch SW4 increases, which compensate for the charge operation of the gate line in the k-th row. At this time, there is a potential difference of VDD−VSS in the capacitor Cb; thus, the node NA increases to 2×VDD−VSS.

Here, the source potential of the switch SW3 is higher than the gate potential of the switch SW3, so that the switch SW3 is turned off. Thus, the potential of the node NC does not become higher than VDD. Therefore, the source-drain voltage (V_{ds}) of the transistor connected to the node NC of the switch SW2 does not increase unnecessarily and the stress to the transistor can be inhibited.

At this time, the SOUT signal at a high-level potential is input to the shift register circuit SR in the next stage as the LIN signal, and precharge of the node NA and discharge of the node NB are performed in the shift register circuit SR in the next stage.

In a period T3, the CLK signal is switched to a low-level potential. Furthermore, the SOUT signal at a high-level potential in the shift register circuit SR in the next stage is input to the gate of the switch SW1b as the RIN signal, the switch SW1b is turned on, and the node NB is charged to have a high-level potential. At this time, current flows through the diode-connected transistor and V_{ds} of the series-connected transistor becomes low in the switch SW2b. When the switch SW2a is turned on, the node NC becomes at a low-level potential. At this time, current flows through the diode-connected transistor and V_{ds} of the series-connected transistor becomes low in the switch SW1a.

When the node NC becomes at a low-level potential, the switch SW3 is turned on, the node NA is discharged to have a low-level potential, and the switch SW4 is turned off. The switch SW5 is turned on, and the SOUT signal becomes at a low-level potential. A potential difference of VDD−VSS is charged in the capacitor Ca.

Through the above operations, the operation of the shift register circuit SR electrically connected to the gate line in the k-th row is completed. Hereinafter, the conduction state of the switch SW5 is maintained and the SOUT signal retains a low-level potential by a potential difference retained in the capacitor Ca until the operation is performed again in the next frame.

The above is the description of the shift register circuit including the semiconductor device of one embodiment of the present invention. Although the example where both the switch SW1 and the switch SW2 included in the semiconductor device are used in the shift register circuit is described, one of the switch SW1 and the switch SW2 may be used.

At least part of this embodiment can be implemented in combination with any of the other embodiments described in this specification, as appropriate.

### Embodiment 2

In this embodiment, a vertical transistor that can be used in the semiconductor device described in Embodiment 1 will be described. The vertical transistor has a structure that facilitates reduction in size and high-speed operation. Note that the vertical transistor can also be used for a pixel circuit and a pixel driver circuit.

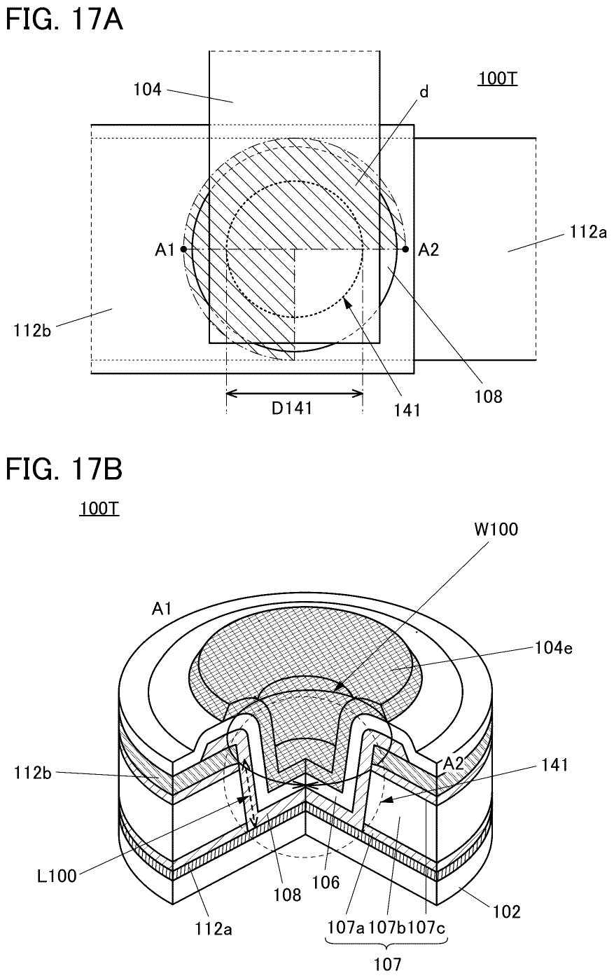

FIGS. 17A and 17B are diagrams illustrating a vertical transistor. FIG. 17A is a top view. FIG. 17B is a cross-sectional perspective view along A1-A2 in the depth direction of a region d hatched in FIG. 17A. Note that for simplification, some components are not illustrated in FIGS. 17A and 17B.

A vertical transistor 100T can be provided over a substrate 102. The transistor 100T includes a conductive layer 104, a conductive layer 104e, an insulating layer 106, a semiconductor layer 108, a conductive layer 112a, and a conductive layer 112b. The conductive layer 104 is a gate line electrically connected to the conductive layer 104e functioning as a gate electrode. Note that the conductive layer 104e may be part of the conductive layer 104. Part of the insulating layer 106 functions as a gate insulating layer. The conductive layer 112a functions as one of a source electrode and a drain electrode. The conductive layer 112b functions as the other of the source electrode and the drain electrode.

The conductive layer 112a is provided over the substrate 102, an insulating layer 107 is provided over the conductive layer 112a, and the conductive layer 112b is provided over the insulating layer 107. The insulating layer 107 has a region interposed between the conductive layer 112a and the conductive layer 112b. The conductive layer 112a has a region overlapping with the conductive layer 112b with the insulating layer 107 therebetween. An opening 141 reaching the conductive layer 112a is provided in the insulating layer 107 and the conductive layer 112b.

Although the conductive layer 112a and the conductive layer 112b each having a single-layer structure are illustrated in FIG. 17B, one embodiment of the present invention is not limited thereto. The conductive layer 112a and the conductive layer 112b can each have a stacked-layer structure.

The top surface shape of the opening 141 can be circular or elliptic, for example. High processing accuracy to form the opening 141 in a minute size is possible when the top surface of the opening 141 has a circular shape. Examples of the top surface shape of the opening 141 can include polygons such as a triangle, a tetragon (including a rectangle, a rhombus, and a square), and a pentagon; and polygons with rounded corners. The opening 141 can be formed using a resist mask, for example.

The semiconductor layer 108 is provided to cover the opening 141. The semiconductor layer 108 includes a region in contact with top and side surfaces of the conductive layer 112b, a side surface of the insulating layer 107, and the top surface of the conductive layer 112a. The semiconductor layer 108 is electrically connected to the conductive layer 112a through the opening 141. The semiconductor layer 108 has a shape along the shapes of the top and side surfaces of the conductive layer 112b, the side surface of the insulating layer 107, and the top surface of the conductive layer 112a.

In the semiconductor layer 108 provided along the side surface of the insulating layer 107, the whole region that is between the source electrode and the drain electrode and overlaps with the gate electrode with the gate insulating layer therebetween functions as a channel formation region. In the semiconductor layer 108, a region in contact with the source electrode functions as a source region and a region in contact with the drain electrode functions as a drain region.

Although the semiconductor layer 108 has a single-layer structure in FIG. 17B and the like, one embodiment of the present invention is not limited thereto. The semiconductor layer 108 can have a stacked-layer structure of two or more layers.

The insulating layer 106 functioning as the gate insulating layer of the transistor 100T is provided over the semiconductor layer 108, the conductive layer 112b, and the insulating layer 107 to cover a depressed portion formed by the opening 141.

The conductive layer 104e of the transistor 100T is provided over the insulating layer 106 to cover the depressed portion formed by the opening 141. Here, an insulating layer (not illustrated) is preferably provided over the conductive layer 104e and the insulating layer 106. An opening reaching the conductive layer 104e is formed in the insulating layer and the conductive layer 104 functioning as a gate line is electrically connected to the conductive layer 104e in the opening.

In the opening 141, the conductive layer 104e includes a region overlapping with the semiconductor layer 108 with the insulating layer 106 therebetween. The conductive layer 104e also includes regions overlapping with the conductive layers 112a and 112b with the insulating layer 106 and the semiconductor layer 108 therebetween. The conductive layer 104e preferably covers an end portion of the conductive layer 112b on the opening 141 side.

The transistor 100T is a so-called top-gate transistor, in which the gate electrode is provided above the semiconductor layer 108. Furthermore, since the bottom surface of the semiconductor layer 108 is in contact with the source electrode or the drain electrode, the transistor 100T can be referred to as a top-gate bottom-contact (TGBC) transistor.

The conductive layers 112a, 112b, and 104 can function as wirings and the transistor 100T can be provided in a region where these wirings overlap with each other. That is, the areas occupied by the transistor 100T and the wirings can be reduced in the circuit including the transistor 100T and the wirings. Therefore, the area occupied by the circuit can be reduced.

In the transistor of one embodiment of the present invention, the conductive layers 112a, 112b, and 104 functioning as wirings can be provided by processing different conductive films. Thus, any one of the conductive layers can be arranged to overlap with at least one of the other conductive layers, leading to high layout flexibility and a reduction in the area occupied by the circuit.

Next, the channel length and the channel width of the transistor 100T will be described. In the semiconductor layer 108, a region in contact with the conductive layer 112a functions as one of a source region and a drain region, a region in contact with the conductive layer 112b functions as the other of the source region and the drain region, and a region between the source region and the drain region functions as a channel formation region.

The channel length of the transistor 100T is a distance between the source region and the drain region. In FIG. 17B, a channel length L100 of the transistor 100T is indicated by a dashed double-headed arrow. In a cross-sectional view, the channel length L100 is a distance between an end portion of the region where the semiconductor layer 108 is in contact with the conductive layer 112a and an end portion of the region where the semiconductor layer 108 is in contact with the conductive layer 112b.

That is, the channel length L100 is determined depending on the thickness of the insulating layer 107 and an angle formed between a side surface of the insulating layer 107 on the opening 141 side and the top surface of the conductive layer 112a, and is not affected by the performance of a light-exposure apparatus used for manufacturing the transistor. Thus, the channel length L100 can be a smaller value than the resolution limit of the light-exposure apparatus and thus the transistor can be miniaturized.

The transistor 100T with a short channel length L100 can have a high on-state current. With use of the transistor 100T, a circuit capable of high-speed operation can be manufactured. Furthermore, the transistor can be downsized, which enables a reduction in the area occupied by the circuit.

Although FIG. 17B and the like illustrate a structure in which the side surface of the insulating layer 107 on the opening 141 side is linear in a cross-sectional view, one embodiment of the present invention is not limited thereto. In a cross-sectional view, the side surface of the insulating layer 107 on the opening 141 side can be curved. Alternatively, the side surface of the insulating layer 107 on the opening 141 side can include both a linear region and a curved region.

The channel width of the transistor 100T is the width of the source region or the drain region in a direction perpendicular to the channel length direction. In other words, the channel width is the width of the region where the semiconductor layer 108 is in contact with the conductive layer 112a or the width of the region where the semiconductor layer 108 is in contact with the conductive layer 112b in the direction perpendicular to the channel length direction. Here, the channel width of the transistor 100T is described as the width of the region where the semiconductor layer 108 is in contact with the conductive layer 112b in the direction perpendicular to the channel length direction. In FIGS. 17A and 17B, a channel width W100 of the transistor 100T is indicated by a solid double-headed arrow. In a top view, the channel width W100 is the length of an end portion of the bottom surface of the conductive layer 112b on the opening 141 side.

The channel width W100 is determined depending on the top surface shape of the opening 141. Assuming that the top surface shape of the opening 141 is circular, the diameter of the opening 141 is D441, and the thickness of the conductive layer 112b is negligible, the channel width W100 can be calculated to be “D441×π”.

In other words, it can be said that the transistor 100T has a large channel width with respect to its occupation area. The transistor 100T with a large channel width W100 can have a high on-state current and thus a circuit capable of high-speed operation can be manufactured.

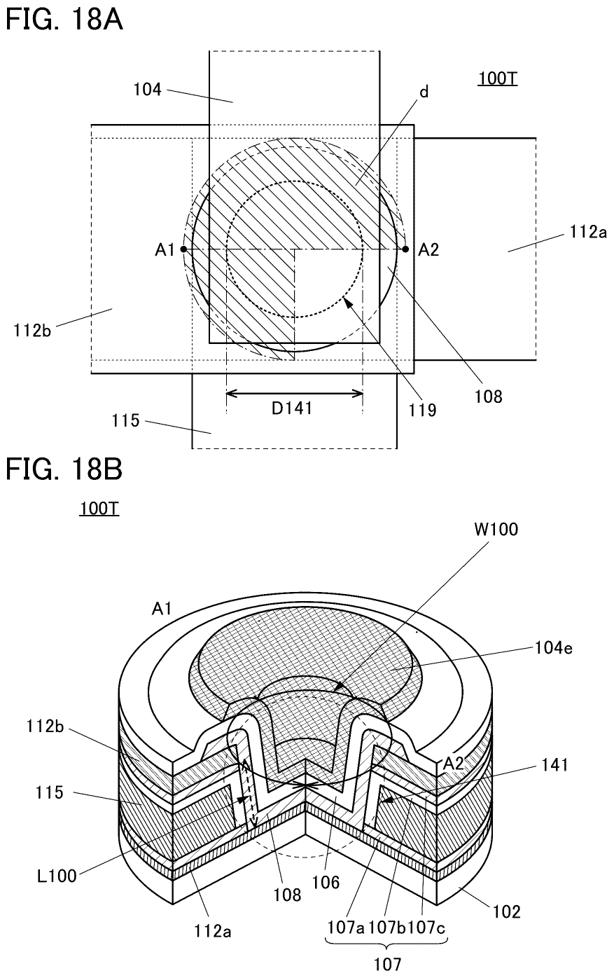

FIGS. 18A and 18B illustrate an example where a back gate is added to the structure in FIGS. 17A and 17B. A conductive layer 115 functioning as a back gate electrode is provided to be embedded in the insulating layer 107 (insulating layers 107a and 107c) and part of an insulating layer 107b provided between the semiconductor layer 108 and the conductive layer 115 functions as a gate insulating layer.

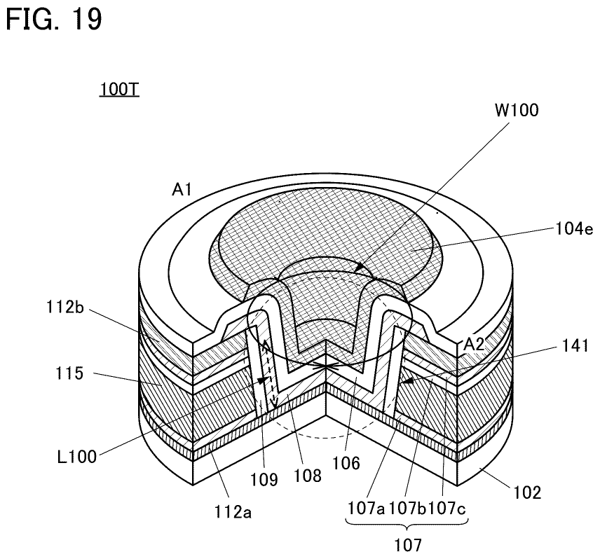

Note that an insulating layer different from the insulating layer 107b may be used as a gate insulating layer. For example, as illustrated in FIG. 19, a sidewall insulating layer 109 may be provided on sidewalls of the conductive layer 112a, the insulating layer 107a, the conductive layer 115, the insulating layer 107b, the insulating layer 107c, and the conductive layer 112b, and the insulating layer 109 may function as a gate insulating layer. Note that the insulating layer 109 is preferably formed using a material similar to that for the insulating layer 106 or the insulating layer 107b.

Hereinafter, the components included in the transistor 100T of this embodiment are described.

### [Components of Transistor]

### [Semiconductor Layer 108]

The semiconductor material that can be used for the semiconductor layer 108 is not particularly limited. For example, a single-element semiconductor or a compound semiconductor can be used. As the single-element semiconductor, silicon or germanium can be used, for example. Examples of the compound semiconductor include gallium arsenide and silicon germanium. As the compound semiconductor, an organic substance having semiconductor characteristics or a metal oxide having semiconductor characteristics (also referred to as an oxide semiconductor) can be used. These semiconductor materials can contain impurities as dopants.

There is no particular limitation on the crystallinity of a semiconductor material used for the semiconductor layer 108, and an amorphous semiconductor or a semiconductor having crystallinity (a single-crystal semiconductor, a polycrystalline semiconductor, a microcrystalline semiconductor, or a semiconductor partly including crystal regions) can be used. It is preferable that a semiconductor having crystallinity be used, in which case deterioration of the transistor characteristics can be inhibited.

The semiconductor layer 108 preferably includes a metal oxide (an oxide semiconductor). Examples of the metal oxide that can be used for the semiconductor layer 108 include indium oxide, gallium oxide, and zinc oxide. The metal oxide preferably contains at least indium (In) or zinc (Zn). The metal oxide preferably contains two or three kinds selected from indium, an element M, and zinc. The element M is one or more kinds selected from gallium, aluminum, silicon, boron, yttrium, tin, antimony, copper, vanadium, beryllium, titanium, iron, nickel, germanium, zirconium, molybdenum, lanthanum, cerium, neodymium, hafnium, tantalum, tungsten, cobalt, and magnesium. Specifically, the element M is preferably one or more kinds selected from aluminum, gallium, yttrium, and tin. The element M is further preferably gallium.

For the semiconductor layer 108, indium oxide, indium gallium oxide (In—Ga oxide), indium zinc oxide (In—Zn oxide), indium tin oxide (In—Sn oxide), indium titanium oxide (In—Ti oxide), gallium zinc oxide (Ga—Zn oxide), indium aluminum zinc oxide (In—A1—Zn oxide, also referred to as IAZO), indium tin zinc oxide (In—Sn—Zn oxide), indium titanium zinc oxide (In—Ti—Zn oxide), indium gallium zinc oxide (In—Ga—Zn oxide, also referred to as IGZO), indium gallium tin zinc oxide (In—Ga—Sn—Zn oxide, also referred to as IGZTO), or indium gallium aluminum zinc oxide (In—Ga—Al—Zn oxide, also referred to as IGAZO or IAGZO) can be used, for example. Alternatively, indium tin oxide containing silicon can be used, for example.

Here, the composition of the metal oxide included in the semiconductor layer 108 greatly affects the electrical characteristics and reliability of the transistor 100T. By increasing the proportion of the number of indium atoms to the sum of the number of atoms of all metal elements in the metal oxide, a transistor having a high on-state current can be provided.

In the case where In—Zn oxide is used for the semiconductor layer 108, it is preferable to use a metal oxide in which the proportion of indium atoms is higher than or equal to that of zinc atoms. For example, it is possible to use a metal oxide in which the atomic ratio of metal elements is In:Zn=1:1, In:Zn=2:1, In:Zn=3:1, In:Zn=4:1, In:Zn=5:1, In:Zn=7:1, or In:Zn=10:1, or in the neighborhood thereof.

In the case where In—Sn oxide is used for the semiconductor layer 108, it is preferable to use a metal oxide in which the proportion of indium atoms is higher than or equal to that of Sn atoms. For example, it is possible to use a metal oxide in which the atomic ratio of metal elements is In:Sn=1:1, In:Sn=2:1, In:Sn=3:1, In:Sn=4:1, In:Sn=5:1, In:Sn=7:1, or In:Sn=10:1, or in the neighborhood thereof.

In the case where In—Sn—Zn oxide is used for the semiconductor layer 108, it is possible to use a metal oxide in which the proportion of indium atoms is higher than that of Sn atoms. Moreover, it is preferable to use a metal oxide in which the proportion of zinc atoms is higher than that of Sn atoms. For example, it is possible to use a metal oxide in which the atomic ratio of metal elements is In:Sn:Zn=2:1:3, In:Sn:Zn=3:1:2, In:Sn:Zn=4:2:3, In:Sn:Zn=4:2:4.1, In:Sn:Zn=5:1:3, In:Sn:Zn=5:1:6, In:Sn:Zn=5:1:7, In:Sn:Zn=5:1:8, In:Sn:Zn=6:1:6, In:Sn:Zn=10:1:3, In:Sn:Zn=10:1:6, In:Sn:Zn=10:1:7, In:Sn:Zn=10:1:8, In:Sn:Zn=5:2:5, In:Sn:Zn=10:1:10, In:Sn:Zn=20:1:10, or In:Sn:Zn=40:1:10, or in the neighborhood thereof.

In the case where In—A1—Zn oxide is used for the semiconductor layer 108, it is possible to use a metal oxide in which the proportion of indium atoms is higher than that of Al atoms. Moreover, it is preferable to use a metal oxide in which the proportion of zinc atoms is higher than that of Al atoms. For example, it is possible to use a metal oxide in which the atomic ratio of metal elements is In:Al:Zn=2:1:3, In:Al:Zn=3:1:2, In:Al:Zn=4:2:3, In:Al:Zn=4:2:4.1, In:Al:Zn=5:1:3, In:Al:Zn=5:1:6, In:Al:Zn=5:1:7, In:Al:Zn=5:1:8, In:Al:Zn=6:1:6, In:Al :Zn=10:1:3, In:Al:Zn=10:1:6, In:Al:Zn=10:1:7, In:Al:Zn=10:1:8, In:Al:Zn=5:2:5, In:Al:Zn=10:1:10, In:Al:Zn=20:1:10, or In:Al:Zn=40:1:10, or in the neighborhood thereof.

In the case where In—Ga—Zn oxide is used for the semiconductor layer 108, it is possible to use a metal oxide in which the proportion of indium atoms to the sum of the number of atoms of all metal elements contained in the In—Ga—Zn oxide is higher than that of gallium atoms. It is further preferable to use a metal oxide in which the proportion of zinc atoms is higher than that of gallium atoms. For example, for the semiconductor layer 108, it is possible to use a metal oxide in which the atomic ratio of metal elements is In:Ga:Zn=2:1:3, In:Ga:Zn=3:1:2, In: Ga:Zn=4:2:3, In:Ga:Zn=4:2:4.1, In:Ga:Zn=5:1:3, In:Ga:Zn=5:1:6, In:Ga:Zn=5:1:7, In:Ga:Zn=5:1:8, In:Ga:Zn=6:1:6, In:Ga:Zn=10:1:3, In:Ga:Zn=10:1:6, In:Ga:Zn=10:1:7, In:Ga:Zn=10:1:8, In:Ga:Zn=5:2:5, In:Ga:Zn=10:1:10, In:Ga:Zn=20:1:10, or In:Ga :Zn=40:1:10, or in the neighborhood thereof.

In the case where In-M-Zn oxide is used for the semiconductor layer 108, it is possible to use a metal oxide in which the proportion of indium atoms to the sum of the number of atoms of all metal elements contained in the In-M-Zn oxide is higher than that of atoms of the element M. It is further preferable to use a metal oxide in which the proportion of zinc atoms is higher than that of atoms of the element M. For example, for the semiconductor layer 108, it is possible to use a metal oxide in which the atomic ratio of metal elements is In:M:Zn=2:1:3, In:M:Zn=3:1:2, In:M:Zn=4:2:3, In:M:Zn=4:2:4.1, In:M:Zn=5:1:3, In:M:Zn=5:1:6, In:M:Zn=5:1:7, In:M:Zn=5:1:8, In:M:Zn=6:1:6, In:M:Zn=10:1:3, In:M:Zn=10:1:6, In:M:Zn=10:1:7, In:M:Zn=10:1:8, In:M:Zn=5:2:5, In:M:Zn=10:1:10, In:M:Zn=20:1:10, or In:M:Zn=40:1:10, or in the neighborhood thereof.

A transistor including a metal oxide with a higher content of indium can have a high on-state current. By using such a transistor as a transistor required to have a high on-state current, a circuit having excellent electrical characteristics can be formed.

Analysis of the composition of a metal oxide can be performed by energy dispersive X-ray spectrometry (EDX), X-ray photoelectron spectrometry (XPS), inductively coupled plasma-mass spectrometry (ICP-MS), or inductively coupled plasma-atomic emission spectrometry (ICP-AES), for example. Alternatively, these methods can be combined as appropriate to be employed for analysis. Note that as for an element whose content is low, the actual content may be different from the content obtained by analysis because of the influence of the analysis accuracy. In the case where the content of the element M is low, for example, the content of the element M obtained by analysis may be lower than the actual content.

In this specification and the like, a composition in the neighborhood includes+30% of an intended atomic ratio. For example, in the case of describing an atomic ratio of In:M:Zn=4:2:3 or a composition in the neighborhood thereof, the case is included in which with the atomic proportion of In being 4, the atomic proportion of M is greater than or equal to 1 and less than or equal to 3 and the atomic proportion of Zn is greater than or equal to 2 and less than or equal to 4. In the case of describing an atomic ratio of In:M:Zn=5:1:6 or a composition in the neighborhood thereof, the case is included in which with the atomic proportion of In being 5, the atomic proportion of M is greater than 0.1 and less than or equal to 2 and the atomic proportion of Zn is greater than or equal to 5 and less than or equal to 7. In the case of describing an atomic ratio of In:M:Zn=1:1:1 or a composition in the neighborhood thereof, the case is included in which with the atomic proportion of In being 1, the atomic proportion of M is greater than 0.1 and less than or equal to 2 and the atomic proportion of Zn is greater than 0.1 and less than or equal to 2.

For forming a metal oxide, a sputtering method or an atomic layer deposition (ALD) method can be suitably employed. Note that in the case where the metal oxide is formed by a sputtering method, the atomic ratio in a target may be different from the atomic ratio in the metal oxide. In particular, the atomic ratio of zinc in the metal oxide may be smaller than the atomic ratio of zinc in the target. Specifically, the metal oxide may have an atomic ratio of zinc of 40% to 90% of the atomic ratio of zinc in the target.

The semiconductor layer 108 can have a stacked-layer structure of two or more metal oxide layers. The two or more metal oxide layers included in the semiconductor layer 108 can have the same or substantially the same composition. The same sputtering target can be used for forming the metal oxide layers that have the same composition and are stacked, for example, so that the manufacturing cost can be reduced.

The two or more metal oxide layers included in the semiconductor layer 108 can have different compositions. For example, a stacked-layer structure of a first metal oxide layer having In:M:Zn=1:3:4 [atomic ratio] or a composition in the neighborhood thereof and a second metal oxide layer having In:M:Zn=1:1:1 [atomic ratio] or a composition in the neighborhood thereof and being formed over the first metal oxide layer can be favorably employed. In particular, gallium or aluminum is preferably used as the element M. For example, a stacked-layer structure of one selected from indium oxide, indium gallium oxide, and IGZO, and one selected from IAZO, IAGZO, and ITZO (registered trademark) can be employed, for example.

It is preferable to use a metal oxide layer having crystallinity as the semiconductor layer 108. For example, a metal oxide layer having a c-axis aligned crystal (CAAC) structure, a polycrystalline structure, a nano-crystal (nc) structure, or the like can be used. By using a metal oxide layer having crystallinity as the semiconductor layer 108, the density of defect states in the semiconductor layer 108 can be reduced, which enables the transistor to have high reliability.

The higher the crystallinity of a metal oxide layer used as the semiconductor layer 108 is, the lower the density of defect states in the semiconductor layer 108 can be. In contrast, the use of a metal oxide layer having low crystallinity enables a transistor to flow a large amount of current. Note that the CAAC structure is a crystal structure in which a plurality of microcrystals (typically, a plurality of IGZO microcrystals) have c-axis alignment and the plurality of microcrystals are connected in the a-b plane without alignment. The CAAC structure has a smaller amount of crystal grain boundary, grain, or the like in the a-b plane than a polycrystalline structure, and thus can achieve a highly reliable semiconductor device.

The semiconductor layer 108 can have a stacked-layer structure of two or more metal oxide layers having different crystallinities. For example, a stacked-layer structure of a first metal oxide layer and a second metal oxide layer over the first metal oxide layer can be employed; the second metal oxide layer can include a region having higher crystallinity than the first metal oxide layer. Alternatively, the second metal oxide layer can include a region having lower crystallinity than the first metal oxide layer. The two or more metal oxide layers included in the semiconductor layer 108 can have the same or substantially the same composition. The same sputtering target can be used for forming the metal oxide layers that have the same composition and are stacked, for example, so that the manufacturing cost can be reduced. For example, with use of the same sputtering target and different oxygen flow rate ratios, a stacked-layer structure of two or more metal oxide layers having different crystallinities can be formed. The two or more metal oxide layers included in the semiconductor layer 108 can have different compositions.

When an oxide semiconductor is used for the semiconductor layer 108, the carrier concentration of the oxide semiconductor functioning as a channel formation region is preferably lower than or equal to 1×10¹⁸ cm⁻³, further preferably lower than 1×10¹⁷ cm⁻³, further preferably lower than 1×10¹⁶ cm⁻³, further preferably lower than 1×10¹³ cm⁻³, further preferably lower than 1×10¹² cm⁻³. The minimum carrier concentration of an oxide semiconductor functioning as a channel formation region is not limited and can be 1×10⁻⁹ cm⁻³, for example.

A transistor including an oxide semiconductor (hereinafter, an OS transistor) has much higher field-effect mobility than a transistor containing amorphous silicon. In addition, the OS transistor has an extremely low leakage current between a source and a drain in an off state (hereinafter also referred to as off-state current), and charge accumulated in a capacitor that is connected in series to the transistor can be retained for a long period. Furthermore, the power consumption of the semiconductor device can be reduced with the OS transistor.

### [Insulating Layer 107]

In the case where an oxide semiconductor is used for the semiconductor layer 108, an inorganic insulating material can be suitably used for the insulating layer 107 (the insulating layer 107a, the insulating layer 107b, and the insulating layer 107c). Note that the insulating layer 107 can have a stacked-layer structure of an inorganic insulating material and an organic insulating material.

As the inorganic insulating material, one or more of an oxide, an oxynitride, a nitride oxide, and a nitride can be used. For the insulating layer 107, for example, one or more of silicon oxide, silicon oxynitride, aluminum oxide, hafnium oxide, yttrium oxide, zirconium oxide, gallium oxide, tantalum oxide, magnesium oxide, lanthanum oxide, cerium oxide, neodymium oxide, silicon nitride, silicon nitride oxide, and aluminum nitride can be used.

Note that in this specification and the like, oxynitride refers to a material that contains more oxygen than nitrogen. Nitride oxide refers to a material that contains more nitrogen than oxygen. For example, silicon oxynitride refers to a material that contains more oxygen than nitrogen, and silicon nitride oxide refers to a material that contains more nitrogen than oxygen.

It is particularly preferable to use an oxide or an oxynitride for the insulating layer 107b. The insulating layer 107b is preferably formed using a film from which oxygen is released by heating. For example, silicon oxide or silicon oxynitride can be suitably used for the insulating layer 107b.

Oxygen released from the insulating layer 107b can be supplied to the semiconductor layer 108. Supplying oxygen from the insulating layer 107b to the semiconductor layer 108, particularly to the channel formation region of the semiconductor layer 108, can allow the amount of oxygen vacancy (V_{O}) and a defect in which hydrogen enters oxygen vacancy (V_{O}H) to be reduced in the semiconductor layer 108, so that a highly reliable transistor having favorable electrical characteristics can be obtained. The insulating layer 107b preferably has a high oxygen diffusion coefficient. Oxygen is easily diffused in the insulating layer 107b having a high oxygen diffusion coefficient, so that oxygen can be efficiently supplied from the insulating layer 107b to the semiconductor layer 108. Examples of treatment for supplying oxygen to the semiconductor layer 108 include heat treatment in an oxygen-containing atmosphere and plasma treatment in an oxygen-containing atmosphere.

It is preferable that the amount of oxygen vacancy (V_{O}) and V_{O}H be reduced in the channel formation region of the transistor 100T. Particularly in the case where the channel length L100 is short, oxygen vacancy (V_{O}) and V_{O}H in the channel formation region greatly affect electrical characteristics and reliability. For example, diffusion of V_{O}H from the source region or the drain region into the channel formation region increases the carrier concentration in the channel formation region, which might cause a change in the threshold voltage or a reduction in the reliability in the transistor 100T. As the channel length L100 of the transistor 100T is shorter, such diffusion of V_{O}H greatly affects electrical characteristics and reliability. Supplying oxygen from the insulating layer 107b to the semiconductor layer 108, particularly to the channel formation region of the semiconductor layer 108, can allow the amount of oxygen vacancy (V_{O}) and V_{O}H to be reduced. Thus, the transistor with a short channel length can have favorable electrical characteristics and high reliability.

The insulating layers 107a and 107c are preferably less likely to transmit oxygen. The insulating layers 107a and 107c function as blocking films that inhibit release of oxygen from the insulating layer 107b. Moreover, the insulating layers 107a and 107c are preferably less likely to transmit hydrogen. The insulating layers 107a and 107c function as blocking films that inhibit diffusion of hydrogen into the semiconductor layer 108 from the outside of the transistor through the insulating layer 107. The insulating layers 107a and 107c preferably have high film densities. The insulating layers 107a and 107c having high film densities can have a high blocking property against oxygen and hydrogen. The film densities of the insulating layers 107a and 107c are preferably higher than that of the insulating layer 107b. In the case where silicon oxide or silicon oxynitride is used for the insulating layer 107b, silicon nitride, silicon nitride oxide, or aluminum oxide can be suitably used for the insulating layers 107a and 107c, for example. The insulating layers 107a and 107c each preferably include a region containing more nitrogen than the insulating layer 107b. A material containing more nitrogen than the insulating layer 107b can be used for the insulating layers 107a and 107c. A nitride or a nitride oxide is preferably used for the insulating layers 107a and 107c. For example, silicon nitride or silicon nitride oxide can be suitably used for the insulating layers 107a and 107c.

When oxygen contained in the insulating layer 107b is diffused upward from a region of the insulating layer 107b that is not in contact with the semiconductor layer 108 (e.g., the top surface of the insulating layer 107b), the amount of oxygen supplied from the insulating layer 107b to the semiconductor layer 108 might be reduced. Provision of the insulating layer 107c over the insulating layer 107b can inhibit diffusion of oxygen contained in the insulating layer 107b from the region of the insulating layer 107 that is not in contact with the semiconductor layer 108. Similarly, provision of the insulating layer 107a under the insulating layer 107b can inhibit downward diffusion of oxygen contained in the insulating layer 107b from the region of the insulating layer 107 that is not in contact with the semiconductor layer 108. Accordingly, the amount of oxygen supplied from the insulating layer 107b to the semiconductor layer 108 is increased, whereby the amount of oxygen vacancy (V_{O}) and V_{O}H in the semiconductor layer 108 can be reduced. Consequently, the transistor can have favorable electrical characteristics and high reliability.

The conductive layers 112a and 112b are oxidized by oxygen contained in the insulating layer 107b and have high resistance in some cases. Moreover, when the conductive layers 112a and 112b are oxidized by oxygen contained in the insulating layer 107b, the amount of oxygen supplied from the insulating layer 107b to the semiconductor layer 108 might be reduced. Provision of the insulating layer 107a between the insulating layer 107b and the conductive layer 112a can inhibit the conductive layer 112a from being oxidized and having high resistance. Similarly, provision of the insulating layer 107c between the insulating layer 107b and the conductive layer 112b can inhibit the conductive layer 112b from being oxidized and having high resistance. In addition, the amount of oxygen supplied from the insulating layer 107b to the semiconductor layer 108 is increased and the amount of oxygen vacancy (V_{O}) and V_{O}H in the semiconductor layer 108 can be reduced, whereby the transistor can have favorable electric characteristics and high reliability.

Hydrogen diffused in the semiconductor layer 108 reacts with an oxygen atom contained in an oxide semiconductor to be water, and thus sometimes forms oxygen vacancy (V_{O}). Furthermore, V_{O}H is formed and the carrier concentration is increased in some cases. Provision of the insulating layers 107a and 107c can allow the amount of oxygen vacancy (V_{O}) and V_{O}H to be reduced in the semiconductor layer 108, whereby the transistor can have favorable electric characteristics and high reliability.

The insulating layers 107a and 107c preferably have thicknesses with which the insulating layers can function as blocking films against oxygen and hydrogen. When the insulating layers 107a and 107c are thin, the function of a blocking film might deteriorate. Meanwhile, when the insulating layers 107a and 107c are thick, a region where the semiconductor layer 108 is in contact with the insulating layer 107b is narrowed and the amount of oxygen supplied from the insulating layer 107b to the semiconductor layer 108 might be reduced. The insulating layers 107a and 107c can each be thinner than the insulating layer 107b.

In the transistor 100T, oxygen is supplied from the insulating layer 107 to the semiconductor layer 108, whereby the amount of oxygen vacancy (V_{O}) and V_{O}H in the channel formation region are reduced. Consequently, the transistor can have favorable electrical characteristics and high reliability.

Note that one or both of the insulating layers 107a and 107c are not necessarily provided.

### [Conductive Layers 112a, 112b, 104, 104e, and 115]

The conductive layers 112a, 112b, 104, 104e, and 115 functioning as a source electrode, a drain electrode, and gate electrodes can each be formed using one or more of chromium, copper, aluminum, gold, silver, zinc, tantalum, titanium, tungsten, manganese, nickel, iron, cobalt, molybdenum, and niobium; or an alloy including one or more of these metals as its components. For the conductive layers 112a, 112b, 104e, and 115, a conductive material with low resistance that contains one or more of copper, silver, gold, and aluminum can be suitably used. Copper or aluminum is particularly preferable because of its high mass-productivity.

As the conductive layers 112a, 112b, 104, 104e, and 115, metal oxide films (also referred to as oxide conductors (OCs)) can be used. Examples of the oxide conductor (OC) include In—Sn oxide (ITO), In—W oxide, In—W—Zn oxide, In—Ti oxide, In—Ti—Sn oxide, In—Zn oxide, In—Sn—Si oxide (ITSO), and In—Ga—Zn oxide.

Here, an oxide conductor (OC) is described. For example, when oxygen vacancy is formed in a metal oxide having semiconductor characteristics and hydrogen is added to the oxygen vacancy, a donor level is formed in the vicinity of the conduction band. As a result, the conductivity of the metal oxide is increased, and thus, the metal oxide becomes a conductor. The metal oxide having become a conductor can be referred to as an oxide conductor.

The conductive layers 112a, 112b, 104, and 104e can each have a stacked-layer structure of a conductive film containing the above-described oxide conductor (metal oxide) and a conductive film containing a metal or an alloy. The use of the conductive film containing a metal or an alloy can reduce the wiring resistance.

A Cu—X alloy film (X is Mn, Ni, Cr, Fe. Co, Mo, Ta, or Ti) can be used as the conductive layers 112a, 112b, 104, and 104e. The use of a Cu—X alloy film results in lower manufacturing cost because the film can be processed by wet etching.

Note that the conductive layers 112a, 112b, 104, 104e, and 115 can be formed using the same material. Alternatively, different materials can be used for the conductive layers 112a, 112b, and 104e.

Here, the conductive layers 112a and 112b will be described in detail with use of a structure in which a metal oxide is used for the semiconductor layer 108 as an example.

When an oxide semiconductor is used for the semiconductor layer 108, the conductive layers 112a and 112b are oxidized by oxygen contained in the semiconductor layer 108 and have high resistance in some cases. The conductive layers 112a and 112b are oxidized by oxygen contained in the insulating layer 107b and have high resistance in some cases. Moreover, when the conductive layers 112a and 112b are oxidized by oxygen contained in the semiconductor layer 108, the amount of oxygen vacancy (V_{O}) in the semiconductor layer 108 is increased in some cases. When the conductive layers 112a and 112b are oxidized by oxygen contained in the insulating layer 107b, the amount of oxygen supplied from the insulating layer 107b to the semiconductor layer 108 might be reduced.

A material that is less likely to be oxidized is preferably used for the conductive layers 112a and 112b. An oxide conductor is preferably used for the conductive layers 112a and 112b. For example, In—Sn oxide (ITO) or In—Sn—Si oxide (ITSO) can be suitably used. A nitride conductor can be used for the conductive layer 112a. Examples of the nitride conductor include tantalum nitride and titanium nitride. The conductive layer 112a can have a stacked-layer structure of the above-described materials.

The conductive layers 112a and 112b including a material that is less likely to be oxidized can be inhibited from being oxidized by oxygen contained in the semiconductor layer 108 or oxygen contained in the insulating layer 107b and having high resistance. Furthermore, it is possible to increase the amount of oxygen supplied from the insulating layer 107b to the semiconductor layer 108 while an increase in the amount of oxygen vacancy (V_{O}) in the semiconductor layer 108 is inhibited. Accordingly, the amount of oxygen vacancy (V_{O}) and V_{O}H in the semiconductor layer 108 can be reduced, whereby the transistor can have favorable electric characteristics and high reliability.

Similarly, when a material that is less likely to be oxidized is used for the conductive layer 112b, the resistance can be inhibited from being increased. Note that the same material can be used for each of the conductive layers 112a and 112b. Alternatively, different materials can be used for the conductive layers 112a and 112b.

The conductive layer 112b has a region in contact with the transistor 100T. When a material that is less likely to be oxidized is used for the conductive layer 112b, the amount of oxygen vacancy (V_{O}) and V_{O}H in the semiconductor layer 108 can be reduced.

As described above, a material that is less likely to be oxidized is preferably used for the conductive layers 112a and 112b in contact with the semiconductor layer 108. However, the use of a material that is less likely to be oxidized might increase the resistance of the conductive layers 112a and 112b. The conductive layers 112a and 112b function as wirings and thus preferably have low resistance. Thus, the conductive layers 112a and 112b can each be a stack of a material that is less likely to be oxidized and a material with low resistance, and the material that is less likely to be oxidized can be in contact with the semiconductor layer 108. With such a structure, the resistance of the conductive layers 112a and 112b can be reduced. Furthermore, the amount of oxygen vacancy (V_{O}) and V_{O}H in the semiconductor layer 108 can be reduced, whereby the transistor can have favorable electric characteristics and high reliability.

As the material that is less likely to be oxidized, one or more of an oxide conductor and a nitride conductor can be suitably used, for example. As a material with low resistance, one or more of copper, aluminum, titanium, tungsten, and molybdenum or an alloy containing one or more of these metals as its components can be suitably used.

### [Insulating Layer 106]

The insulating layer 106 functioning as a gate insulating layer preferably has low defect density. With the insulating layer 106 having low defect density, the transistor can have favorable electrical characteristics. In addition, the insulating layer 106 preferably has high withstand voltage. With the insulating layer 106 having high withstand voltage, the transistor can have high reliability.

For the insulating layer 106, one or more of an insulating oxide, an insulating oxynitride, an insulating nitride oxide, and an insulating nitride can be used, for example. For the insulating layer 106, one or more of silicon oxide, silicon oxynitride, silicon nitride oxide, silicon nitride, aluminum oxide, aluminum oxynitride, aluminum nitride oxide, aluminum nitride, hafnium oxide, hafnium oxynitride, gallium oxide, gallium oxynitride, yttrium oxide, yttrium oxynitride, and Ga-Zn oxide can be used. The insulating layer 106 is not limited to having a single-layer structure and can have a stacked-layer structure. The insulating layer 106 can have a stacked-layer structure of an oxide and a nitride.

A miniaturized transistor including a thin gate insulating layer may have a large leakage current. When a high dielectric constant material (also referred to as a high-k material) is used for the gate insulating layer, the voltage at the time of operation of the transistor can be reduced while the physical thickness is maintained. Examples of the high-k material include gallium oxide, hafnium oxide, zirconium oxide, an oxide containing aluminum and hafnium, an oxynitride containing aluminum and hafnium, an oxide containing silicon and hafnium, an oxynitride containing silicon and hafnium, and a nitride containing silicon and hafnium.

The amount of impurities (e.g., water and hydrogen) released from the insulating layer 106 itself is preferably small. With the insulating layer 106 from which a small amount of impurities is released, diffusion of impurities into the semiconductor layer 108 is inhibited, and the transistor can have favorable electrical characteristics and high reliability.

Here, the insulating layer 106 will be described in detail with use of a structure in which a metal oxide is used for the semiconductor layer 108 as an example.

To improve the properties of the interface with the semiconductor layer 108, at least the side of the insulating layer 106, which is in contact with the semiconductor layer 108, is preferably include an oxide. For example, one or more of silicon oxide and silicon oxynitride can be suitably used for the insulating layer 106. A film from which oxygen is released by heating is further preferably used as the insulating layer 106.

Note that the insulating layer 106 can have a stacked-layer structure. The insulating layer 106 can have a stacked-layer structure of an oxide film on the side in contact with the semiconductor layer 108 and a nitride film on the side in contact with the conductive layer 104e. For example, one or more of silicon oxide and silicon oxynitride can be suitably used for the oxide film. Silicon nitride can be suitably used for the nitride film.

### [Substrate 102]

There is no particular limitation on the properties of a material of the substrate 102 as long as the material has heat resistance enough to withstand at least heat treatment to be performed later. For example, a single crystal semiconductor substrate or a polycrystalline semiconductor substrate of silicon or silicon carbide, a compound semiconductor substrate of silicon germanium or the like, an SOI substrate, a glass substrate, a quartz substrate, a sapphire substrate, a ceramic substrate, or an organic resin substrate can be used as the substrate 102. Alternatively, any of these substrates provided with a semiconductor element can be used as the substrate 102. Note that the shape of the semiconductor substrate and an insulating substrate can be circular or square.

A flexible substrate may be used as the substrate 102, and the transistor 100T and the like can be formed directly on the flexible substrate. Alternatively, a separation layer can be provided between the substrate 102 and the transistor 100T and the like. The separation layer can be used when part or the whole of a semiconductor device completed thereover is separated from the substrate 102 and transferred onto another substrate. In such a case, the transistor 100T and the like can be transferred to a substrate having low heat resistance or a flexible substrate as well.

The above is the description of the components of the transistor 100T.

At least part of this embodiment can be implemented in combination with any of the other embodiments described in this specification, as appropriate.

### Embodiment 3

In this embodiment, an example of a layout of a semiconductor device of one embodiment of the present invention will be described.

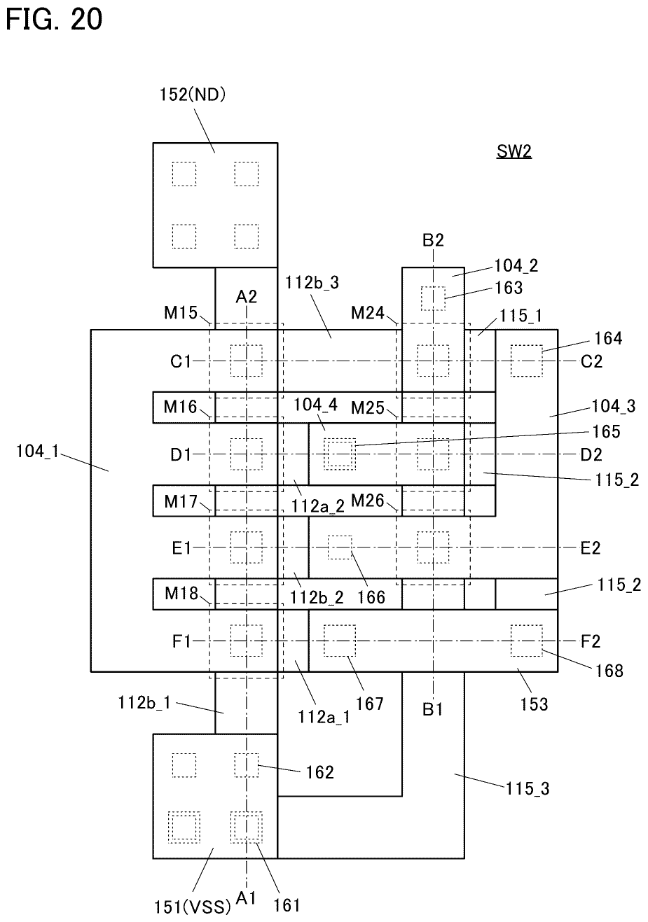

FIG. 20 is a top view illustrating an example of a layout of the switch SW2 in the semiconductor device illustrated in FIG. 7B in Embodiment 1. The transistors M15 to M18 and the transistors M24 to M26 (the diodes D14 to D16) illustrated in FIG. 20 can be formed using the vertical transistor described in Embodiment 2.

In FIG. 20, the same reference numeral as in FIGS. 17A and 17B and FIGS. 18A and 18B illustrating the vertical transistor described in Embodiment 2 is used, and the conductive layer 112a (conductive layers 112a_1 and 112a 2), the conductive layer 112b (conductive layers 112b 1 to 112b_3), the conductive layer 104 (conductive layers 104_1 to 104_4), and the conductive layer 115 (conductive layers 115_1 to 115_3) are illustrated. Note that the semiconductor layer and the insulating layers are not illustrated.

In addition, opening portions 161 to 168 for connecting different conductive layers are illustrated. Conductive layers 151 to 153 that can be formed in the same step as the conductive layer 104 are illustrated. The conductive layer 151 functions as part of a low potential power supply line for supplying VSS, the conductive layer 152 functions as part of the node ND, and the conductive layer 153 functions as a connection wiring.

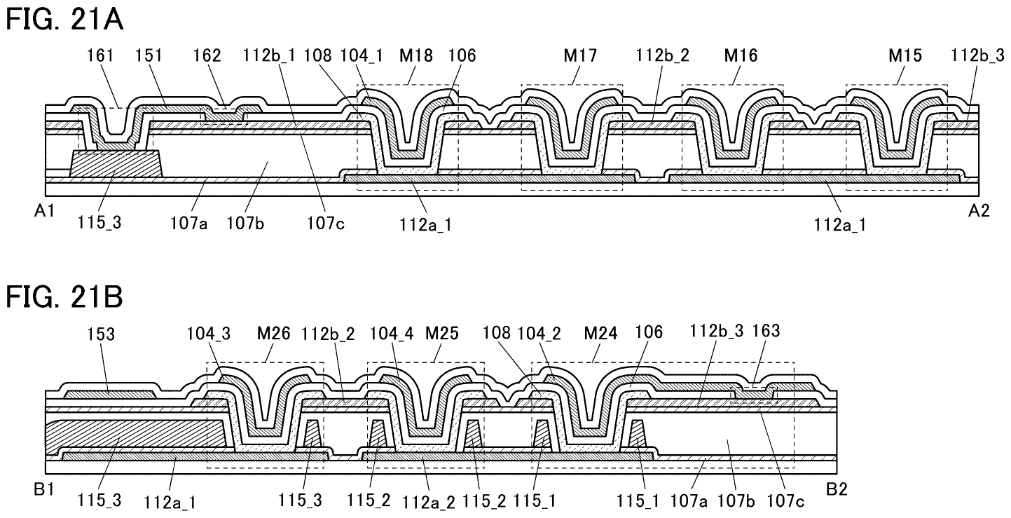

Next, a connection mode of each component of the semiconductor device is described with reference to cross-sectional views. FIG. 21A is a cross-sectional view taken along the line segment A1-A2 in FIG. 20, and illustrates the transistors M15 to M18 that include a common gate electrode (the conductive layer 104_1) and thus are directly connected to each other and the conductive layer 151 (the low potential power supply line).

In the vertical transistor, one of the conductive layer 112a and the conductive layer 112b functions as a source electrode, and the other of the conductive layer 112a and the conductive layer 112b functions as a drain electrode. Thus, when transistors are connected in series, components can be simplified by connecting lower electrodes or upper electrodes of the adjacent transistors.

For example, as illustrated in FIG. 21A, electrical connection is preferably established in such a manner that the transistor M15 and the transistor M16 share the conductive layer 112a_1 serving as a lower electrode. In addition, electrical connection is preferably established in such a manner that the transistor M16 and the transistor M17 share the conductive layer 112b_2 serving as an upper electrode. In addition, electrical connection is preferably established in such a manner that the transistor M17 and the transistor M18 share the conductive layer 112a_1 serving as a lower electrode.

Here, the conductive layer 112a_1 is a source electrode in the transistor M15 and a drain electrode in the transistor M16. The conductive layer 112b_2 is a source electrode in the transistor M16 and is a drain electrode in the transistor M17. The conductive layer 112a_1 is a source electrode in the transistor M17 and is a drain electrode in the transistor M18. The conductive layer 112b_1 serves as a source electrode in the transistor M18.

With such a structure, an opening portion or the like for connecting the upper electrode and the lower electrode does not need to be provided, so that the area occupied by the circuit can be reduced.

The conductive layer 151 corresponding to the low potential power supply line can be formed using the same material in the same step as the conductive layer 104 used for a gate wiring of the transistor. The conductive layer 151 is electrically connected to the conductive layer 112b_1 in the opening portion 162 provided in the insulating layer 106. The conductive layer 151 is electrically connected to the conductive layer 115_3 in the opening portion 161 provided in the insulating layers 107b and 107c, the conductive layer 112b, and the insulating layer 106. The conductive layer 115_3 extends to the position of the transistor M26 as illustrated in FIG. 21B and functions as a back gate electrode.

FIG. 21B is a cross-sectional view taken along the line segment B1-B2 in FIG. 20, and illustrates the transistors M24 to M26 functioning as the diodes D14 to D16 and a connection portion of the gate and the drain of the transistor M24.

The transistor M24 is electrically connected to the transistor M25 in a mode in which the conductive layer 112a_2 serving as a lower electrode is shared. Here, the conductive layer 112a 2 is a source electrode in the transistor M24 and a drain electrode in the transistor M25.

In the transistor M24, the conductive layer 104_2 and the conductive layer 112b_3 are electrically connected to each other in the opening portion 163 provided in the insulating layer 106. Here, the conductive layer 104_2 is a gate electrode and the conductive layer 112b_3 is a drain electrode. That is, the connection is diode connection, so that the transistor M24 can operate as the diode D14.

The transistor M25 is electrically connected to the transistor M26 in a mode in which the conductive layer 112b_2 serving as an upper electrode is shared. Here, the conductive layer 112b_2 is a source electrode in the transistor M25 and a drain electrode in the transistor M26. The conductive layer 112a_1 serves as a source electrode in the transistor M26. Note that diode connection of the transistors M25 and M26 will be described later.

The transistors M24 to M26 each include the conductive layer 115 functioning as a back gate. The conductive layer 115 is provided to be embedded in the insulating layer 107 (the insulating layers 107a, 107b, and 107c) and part of the insulating layer 107b functions as a gate insulating film.

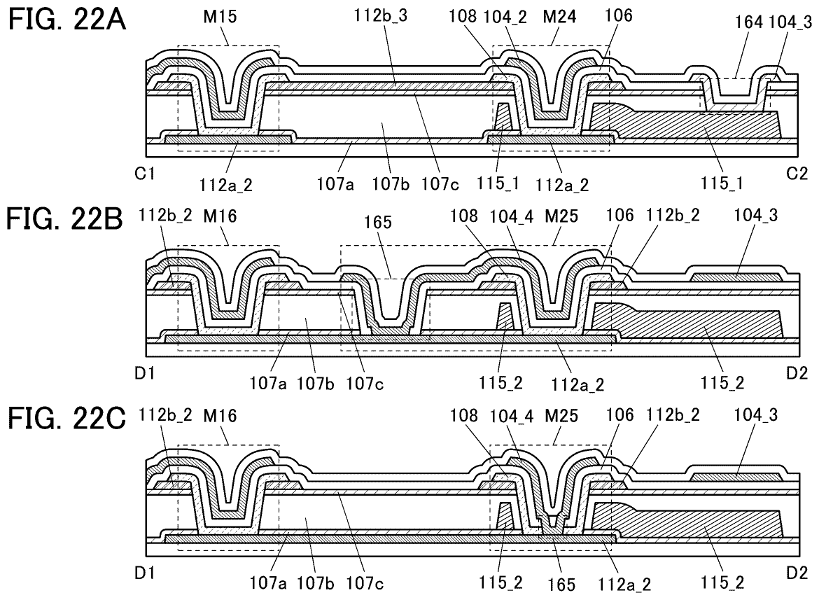

FIG. 22A is a cross-sectional view taken along the line segment C1-C2 in FIG. 20, which illustrates the transistor M15, the transistor M24 functioning as the diode D14, and the conductive layer 104_3 connected to the back gate of the transistor M24.

The transistor M15 is electrically connected to the transistor M24 with the shared use of the conductive layer 112b_3. Here, the conductive layer 112b is a drain electrode in both the transistor M15 and the transistor M24. The conductive layer 112b_3 is electrically connected to the node ND.

The conductive layer 115_1 functioning as the back gate of the transistor M24 is electrically connected to the conductive layer 104_3 in the insulating layers 107b and 107c and the opening portion 164 provided in the insulating layer 106. The conductive layer 104_3 is a gate electrode of the transistor M26 and is connected to the source of the transistor M25. The connection will be described later.

FIG. 22B is a cross-sectional view taken along the line segment D1-D2 in FIG. 20 and illustrates the transistor M16 and the transistor M25 functioning as and the diode D15.

The transistor M16 is electrically connected to the transistor M25 in a mode in which the conductive layer 112a_2 is shared. Here, the conductive layer 112a_2 is a drain electrode in both the transistor M16 and the transistor M25.

The conductive layer 104_4, which is a gate electrode of the transistor M25, is electrically connected to the conductive layer 112a_2 in the opening portion 165 provided in the insulating layer 107 and the insulating layer 106. That is, the connection is diode connection, so that the transistor M25 can operate as the diode D15.

Note that the opening portion 165 for diode connection is not limited to the position illustrated in FIG. 22B. For example, as illustrated in FIG. 22C, the opening portion 165 may be provided at a position overlapping with the transistor M25. In this case, the opening portion 165 can be provided in the semiconductor layer 108 and the insulating layer 106 to overlap with the opening portion for manufacturing the transistor M25. When diode connection is performed at such a position, the area occupied by the circuit can be reduced in some cases.

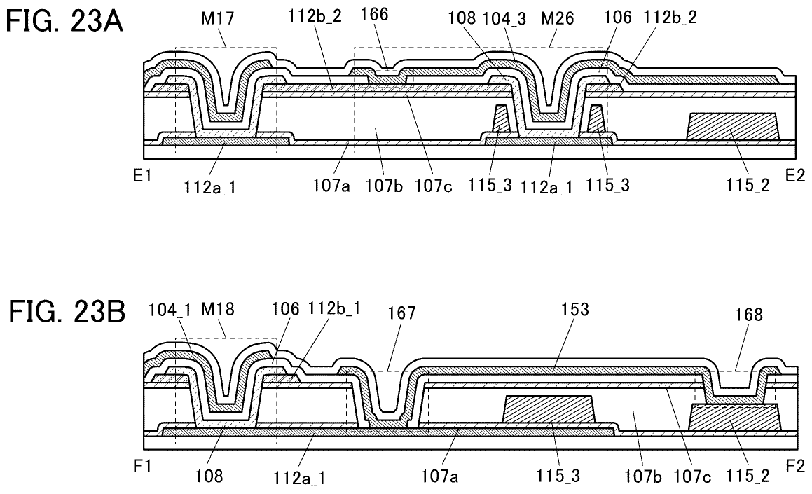

FIG. 23A is a cross-sectional view taken along the line segment E1-E2 in FIG. 20 and illustrates the transistor M17 and the transistor M26 functioning as the diode D16.

The transistor M17 is electrically connected to the transistor M26 in a mode in which the conductive layer 112b_2 is shared. Here, the conductive layer 112a is a drain electrode in both the transistor M17 and the transistor M26.

The conductive layer 104_3, which is the gate electrode of the transistor M26, is electrically connected to the conductive layer 112b_2 in the opening portion 166 provided in the insulating layer 106. That is, the connection is diode connection, so that the transistor M26 can operate as the diode D16. As illustrated in FIG. 22A, the conductive layer 104_3 is electrically connected to the conductive layer 115_1 functioning as a back gate electrode of the transistor M24.

FIG. 23B is a cross-sectional view taken along the line segment F1-F2 in FIG. 20, which illustrates the transistor M18 and a connection portion between the conductive layer 153 and another wiring.

The conductive layer 112a 1, which is the lower electrode of the transistor M18, functions as a drain and is electrically connected to the conductive layer 153 in the opening portion 167 provided in the insulating layer 107 and the insulating layer 106. The conductive layer 153 is electrically connected to the conductive layer 115_2 in the opening portion 168 provided in the insulating layers 107b and 107c and the insulating layer 106. The conductive layer 115_2 extends to the position of the transistor M25 and functions as a back gate electrode.

At least part of this embodiment can be implemented in combination with any of the other embodiments described in this specification, as appropriate.

### Embodiment 4

This embodiment will explain a display device that can include the semiconductor device described in Embodiment 1. The semiconductor device can be used as a component of a pixel driver circuit included in the display device.

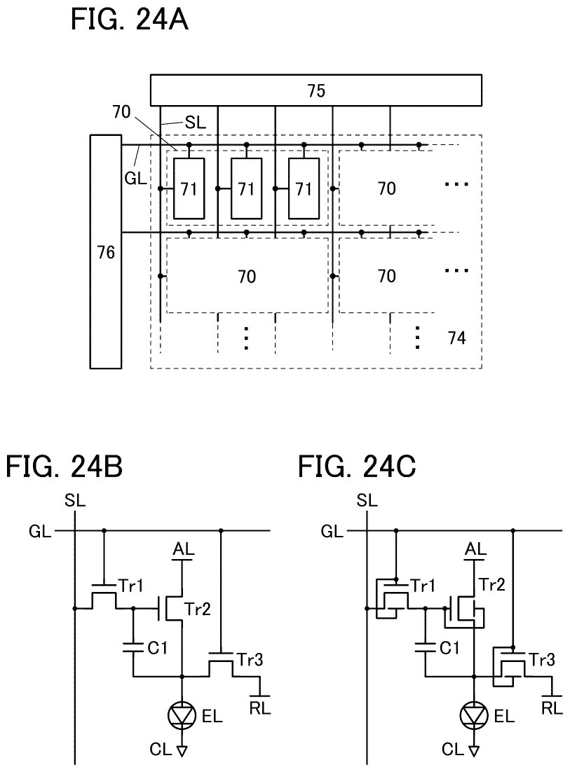

FIG. 24A is a block diagram illustrating a display panel. The display panel includes a pixel array 74, a circuit 75, and a circuit 76. The pixel array 74 includes pixels 70 arranged in a column direction and a row direction.

The pixel 70 can include a plurality of subpixels 71. The subpixel 71 has a function of emitting light for display. When colors of R (red), G (green), B (blue), and the like are assigned to light emitted from the subpixels 71, full-color display can be performed.

The subpixel 71 includes a light-emitting element (also referred to as a light-emitting device) that emits visible light. As the light-emitting element, an EL element such as an organic light-emitting diode (OLED) or a quantum-dot light-emitting diode (QLED) is preferably used. Examples of a light-emitting substance contained in the EL element include a substance exhibiting fluorescence (a fluorescent material), a substance exhibiting phosphorescence (a phosphorescent material), a substance exhibiting thermally activated delayed fluorescence (a thermally activated delayed fluorescent (TADF) material), and an inorganic compound (e.g., a quantum dot material). Alternatively, a light-emitting diode (LED) such as a micro-LED can be used as the light-emitting element. Furthermore, a non-light-emitting element such as a liquid crystal device can be used for the subpixel 71. Note that in this embodiment, the above-described subpixel is simply referred to as a pixel in some cases.

The circuit 75 and the circuit 76 are driver circuits for driving the subpixel 71. The circuit 75 can have a function of a source driver circuit and the circuit 76 can have a function of a gate driver circuit. The circuit 75 is electrically connected to the pixels through a source line SL. The circuit 76 is electrically connected to the pixels through a gate line GL.

A shift register circuit or the like described in Embodiment 1 can be used as the circuit 75 and the circuit 76, for example. That is, the semiconductor device of one embodiment of the present invention can be used for the circuit 75 and the circuit 76, so that the reliability of the display panel can be increased.

FIG. 24B illustrates a pixel circuit that can be used as the pixel. The pixel circuit includes a transistor Tr1, a transistor T2, a transistor T3, a capacitor C1, and a light-emitting element EL. The gate line GL and the source line SL are electrically connected to the pixel circuit (see FIG. 24A).

A gate of the transistor Tr1 is electrically connected to the gate line GL, one of a source and a drain of the transistor Tr1 is electrically connected to the source line SL, and the other of the source and the drain of the transistor Tr1 is electrically connected to one electrode of the capacitor C1 and a gate of the transistor Tr2. One of a source and a drain of the transistor Tr2 is electrically connected to a wiring AL, and the other of the source and the drain of the transistor Tr2 is electrically connected to one electrode of the light-emitting element EL, the other electrode of the capacitor C1, and one of a source and a drain of the transistor Tr3. A gate of the transistor Tr3 is electrically connected to the gate line GL, and the other of the source and the drain of the transistor Tr3 is electrically connected to a wiring RL. The other electrode of the light-emitting element EL is electrically connected to a wiring CL.

A data potential is supplied to the source line SL. A selection signal is supplied to the gate line GL. The selection signal includes a potential for turning on a transistor and a potential for turning off the transistor.

A reset potential is supplied to the wiring RL. An anode potential is supplied to the wiring AL. A cathode potential is supplied to the wiring CL. The anode potential is higher than the cathode potential. The reset potential supplied to the wiring RL can be set such that a potential difference between the reset potential and the cathode potential is lower than the threshold voltage of the light-emitting element EL. The reset potential can be a potential higher than the cathode potential, a potential equal to the cathode potential, or a potential lower than the cathode potential.

Each of the transistor Tr1 and the transistor Tr3 functions as a switch. The transistor Tr2 functions as a transistor for controlling current flowing through the light-emitting element EL. For example, it can be regarded that the transistor Tr1 functions as a selection transistor and the transistor Tr3 functions as a driving transistor.

Here, a transistor containing a metal oxide in a channel formation region (hereinafter also referred to as an OS transistor) can be used as the transistors Tr1 to Tr3. Alternatively, transistors containing silicon (single crystal silicon, polycrystalline silicon, microcrystalline silicon, or amorphous silicon) in their channel formation regions (hereinafter, Si transistors) can be used as all of the transistors Tr1 to Tr3. Alternatively, OS transistors can be used as the transistors Tr1 and Tr3, and a Si transistor can be used as the transistor Tr2.

A structure can be employed in which one or more Si transistors are used as the plurality of transistors included in the circuits 75 and 76 and OS transistors are used as the other transistors. One or more of the circuits 75 and 76 can be formed using Si transistors and the other can be formed using OS transistors.

As the OS transistor, a transistor including an oxide semiconductor in its semiconductor layer where a channel is formed can be used. The semiconductor layer preferably contains indium, M (M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium), and zinc, for example.

Specifically, the element M is preferably one or more kinds selected from aluminum, gallium, yttrium, and tin. It is particularly preferable to use an oxide containing indium, gallium, and zinc (also referred to as IGZO) for the semiconductor layer of the OS transistor. Alternatively, it is preferable to use an oxide containing indium, tin, and zinc. Alternatively, it is preferable to use an oxide containing indium, gallium, tin, and zinc.

A transistor using an oxide semiconductor having a wider band gap and a lower carrier concentration than silicon can achieve an extremely low off-state current. Therefore, owing to the low off-state current, charge accumulated in a capacitor that is connected in series to the transistor can be retained for a long time. Hence, it is preferable to use transistors containing an oxide semiconductor as, especially, the transistors Tr1 and Tr3 connected in series to the capacitor C1. The use of the transistors containing an oxide semiconductor as the transistors Tr1 and Tr3 can prevent leakage of charge retained in the capacitor C1 through the transistor Tr1 or the transistor Tr3. Furthermore, since charge retained in the capacitor C1 can be retained for a long period, a still image can be displayed for a long period without rewriting data in the pixel.

Although all the transistors are n-channel transistors in FIG. 24B, a p-channel transistor can also be used.

A transistor including a pair of gates overlapping with a semiconductor layer therebetween can be used as the transistor included in the pixel circuit.

In the transistor including a pair of gates, the same potential is supplied to the pair of gates electrically connected to each other, whereby the on-state current of the transistor can be increased and the saturation characteristics can be improved. A potential for controlling the threshold voltage of the transistor can be supplied to one of the pair of gates. Furthermore, when a constant potential is supplied to one of the pair of gates, the stability of the electrical characteristics of the transistor can be improved. For example, one of the gates of the transistor can be electrically connected to a wiring to which a constant potential is supplied. Alternatively, one of the gates of the transistor can be electrically connected to a source or a drain.

FIG. 24C illustrates an example of the pixel circuit in which a transistor including a pair of gates is used as each of the transistors Tr1 and Tr3. The pair of gates are electrically connected to each other in each of the transistors Tr1 and Tr3. Such a structure makes it possible to shorten the period in which data is written to the pixel circuit.

Next, an example of a display panel including a light-emitting element as a display element is described. The display panel includes two or more pixels that emit light of different colors. Each of the pixels includes a light-emitting element. The light-emitting elements each include a pair of electrodes and an EL layer therebetween. The light-emitting elements are preferably organic electroluminescent elements (organic EL elements). The two or more light-emitting elements emitting light of different colors include respective EL layers containing different light-emitting materials. For example, three kinds of light-emitting elements emitting red (R), green (G), and blue (B) light are included, whereby a full-color display panel can be obtained.

In the case of manufacturing a display panel including a plurality of light-emitting elements emitting light of different colors, at least layers (light-emitting layers) containing light-emitting materials different in emission color each need to be formed in an island shape. In a known method for separately forming part or the whole of an EL layer, an island-shaped organic film is formed by an evaporation method using a shadow mask such as a metal mask. However, this method has difficulty in achieving high resolution and a high aperture ratio of a display panel because in this method, a deviation from the designed shape and position of the island-shaped organic film is caused by various influences such as the low accuracy of the metal mask position, the positional deviation between the metal mask and a substrate, a warp of the metal mask, and the vapor-scattering-induced expansion of the outline of the formed film. In addition, the outline of a layer may blur during vapor deposition, whereby the thickness of its end portion may be small. That is, the thickness of an island-shaped light-emitting layer may vary from area to area. In the case of manufacturing a display panel with a large size, high definition, or high resolution, the manufacturing yield might be reduced because of low dimensional accuracy of the metal mask and deformation due to heat or the like. Thus, a measure has been taken for pseudo improvement in resolution (also referred to pixel density). As a specific measure, unique pixel arrangement such as a PenTile pattern has been employed.

Note that in this specification and the like, the term “island shape” refers to a state where two or more layers formed using the same material in the same step are physically separated from each other. For example, “island-shaped light-emitting layer” means a state where the light-emitting layer and its adjacent light-emitting layer are physically separated from each other.

In the example of this embodiment, fine patterning of an EL layer is performed by a photolithography without a shadow mask such as a fine metal mask (FMM). With the patterning, a high-resolution display panel with a high aperture ratio, which has been difficult to achieve, can be manufactured. Moreover, EL layers can be formed separately, enabling the display panel to perform extremely clear display with high contrast and high display quality. Note that, fine patterning of an EL layer may be performed using both a metal mask and photolithography, for example.

Part or the whole of the EL layer can be physically divided, inhibiting leakage current flowing between adjacent light-emitting elements through a layer (also referred to as a common layer) shared by the light-emitting elements. This can prevent light emission due to unintended crosstalk, so that a display panel with extremely high contrast can be obtained. Specifically, a display panel having high current efficiency at low luminance can be obtained.

Note that the display panel of one embodiment of the present invention can also be obtained by combining white-light-emitting elements with a color filter. In that case, the light-emitting elements having the same structure can be provided in pixels (subpixels) emitting light of different colors, allowing all the layers to be common layers. Furthermore, part or the whole of the EL layer may be divided in a process using photolithography. Thus, leakage current through a common layer is suppressed; accordingly, a high-contrast display panel is achieved. In particular, when an element has a tandem structure in which a plurality of light-emitting layers are stacked with a highly conductive intermediate layer therebetween, leakage current through the intermediate layer can be effectively prevented, achieving a display panel with high luminance, high resolution, and high contrast.

In the case where the EL layer is processed by photolithography, part of the light-emitting layer is sometimes exposed to cause deterioration. For this reason, an insulating layer covering at least a side surface of the island-shaped light-emitting layer is preferably provided. The insulating layer may cover part of the top surface of the island-shaped EL layer. For the insulating layer, a material having a barrier property against water and oxygen is preferably used. For example, an inorganic insulating film that is less likely to diffuse water and oxygen can be used. Thus, the deterioration of the EL layer is inhibited, and a highly reliable display panel can be achieved.

Between two light-emitting elements that are adjacent to each other, there is a region (a depressed portion) where the EL layers of the light-emitting elements are not provided. In the case where the depressed portion is covered with a common electrode or with a common electrode and a common layer, the common electrode might be disconnected (or “disconnection”) by a step at an end portion of the EL layer, thereby causing insulation of the common electrode over the EL layer. In view of this, the local gap between the two adjacent light-emitting elements is preferably filled with a resin layer (also referred to as local filling planarization, or LFP) serving as a planarization film. The resin layer has a function of a planarization film. This structure can inhibit a disconnection of the common layer or the common electrode, making it possible to obtain a highly reliable display panel.

More specific structure examples of the display panel of one embodiment of the present invention will be described below with reference to drawings.

### Structure Example 1

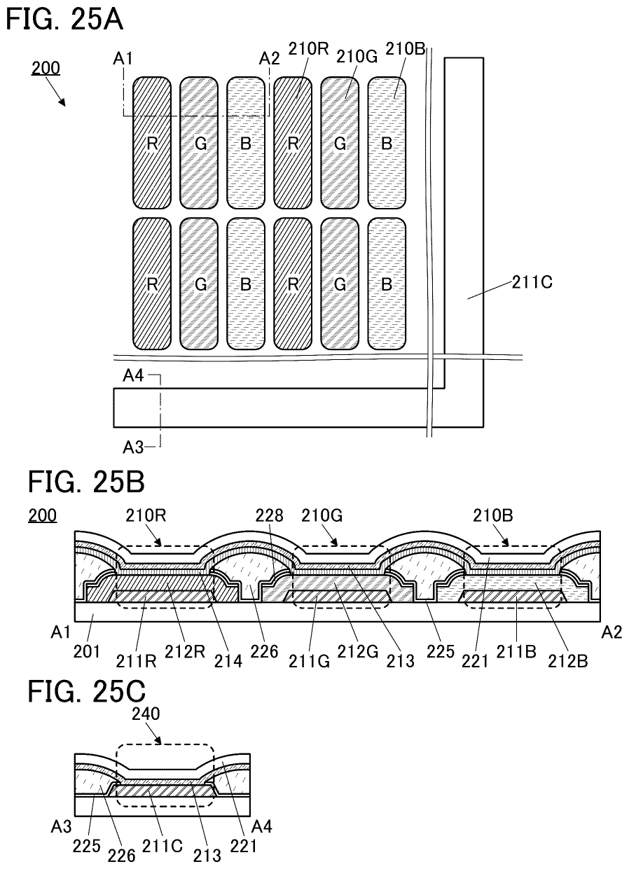

FIG. 25A is a schematic top view of a display panel 200 of one embodiment of the present invention. The display panel 200 includes, over a substrate 201, a plurality of light-emitting elements 210R exhibiting red, a plurality of light-emitting elements 210G exhibiting green, and a plurality of light-emitting elements 210B exhibiting blue. In FIG. 25A, light-emitting regions of the light-emitting elements are denoted by R, G, and B to easily differentiate the light-emitting elements.

The light-emitting elements 210R, the light-emitting elements 210G, and the light-emitting elements 210B are arranged in a matrix. FIG. 25A illustrates what is called stripe arrangement, in which light-emitting elements of the same color are arranged in one direction. Note that the arrangement of the light-emitting elements is not limited thereto; another arrangement such as S stripe, delta, Bayer, zigzag, PenTile, or diamond pattern may also be used.

As each of the light-emitting elements 210R, 210G, and 210B, an EL element such as an organic light-emitting diode (OLED) or a quantum-dot light-emitting diode (QLED) is preferably used, for example. Examples of the light-emitting substance contained in the EL element include not only organic compounds but also inorganic compounds (e.g., quantum dot materials).

FIG. 25A also illustrates a connection electrode 211C that is electrically connected to a common electrode 213. The connection electrode 211C is supplied with a potential (e.g., an anode potential or a cathode potential) that is to be supplied to the common electrode 213. The connection electrode 211C is provided outside a display region where the light-emitting elements 210R and the like are arranged.

The connection electrode 211C can be provided along the outer periphery of the display region. For example, the connection electrode 211C may be provided along one side of the outer periphery of the display region or two or more sides of the outer periphery of the display region. That is, in the case where the display region has a rectangular top surface, the top surface of the connection electrode 211C can have a band shape (a rectangular shape), an L shape, a square bracket shape, a quadrangular shape, or the like. Note that in this specification and the like, the top surface shape is referred to as a shape in a plan view, that is, a shape seen from above.

FIGS. 25B and 25C are the schematic cross-sectional views taken along the dashed-dotted line A1-A2 and the dashed-dotted line A3-A4 in FIG. 25A. FIG. 25B is a schematic cross-sectional view of the light-emitting element 210R, the light-emitting element 210G, and the light-emitting element 210B, and FIG. 25C is a schematic cross-sectional view of a connection portion 240 to which the connection electrode 211C and the common electrode 213 are connected.

The light-emitting element 210R includes a pixel electrode 211R, an organic layer 212R, a common layer 214, and the common electrode 213. The light-emitting element 210G includes a pixel electrode 211G, an organic layer 212G, the common layer 214, and the common electrode 213. The light-emitting element 210B includes a pixel electrode 211B, an organic layer 212B, the common layer 214, and the common electrode 213. The common layer 214 and the common electrode 213 are shared by the light-emitting element 210R, the light-emitting element 210G, and the light-emitting element 210B.

The organic layer 212R of the light-emitting element 210R contains at least a light-emitting organic compound that emits red light. The organic layer 212G of the light-emitting element 210G contains at least a light-emitting organic compound that emits green light. The organic layer 212B of the light-emitting element 210B contains at least a light-emitting organic compound that emits blue light. Each of the organic layers 212R, 212G, and 212B can also be referred to as an EL layer, and includes at least a layer containing a light-emitting substance (a light-emitting layer).

Hereafter, the term “light-emitting element 210” is sometimes used to describe matters common to the light-emitting elements 210R, 210G, and 210B. Likewise, in the description of matters common to the components that are distinguished using alphabets, such as the organic layers 212R, 212G, and 212B, reference numerals without such alphabets are sometimes used.

The organic layer 212 and the common layer 214 can each independently include one or more of an electron-injection layer, an electron-transport layer, a hole-injection layer, and a hole-transport layer. For example, the organic layer 212 can include a hole-injection layer, a hole-transport layer, a light-emitting layer, and an electron-transport layer that are stacked from the pixel electrode 211 side, and the common layer 214 can include an electron-injection layer.

The pixel electrode 211R, the pixel electrode 211G, and the pixel electrode 211B are provided for the respective light-emitting elements. Each of the common electrode 213 and the common layer 214 is provided as a continuous layer shared by the light-emitting elements. A conductive film that has a property of transmitting visible light is used for either the respective pixel electrodes or the common electrode 213, and a reflective conductive film is used for the other. When the respective pixel electrodes are light-transmitting electrodes and the common electrode 213 is a reflective electrode, a bottom-emission display panel is obtained. When the respective pixel electrodes are reflective electrodes and the common electrode 213 is a light-transmitting electrode, a top-emission display panel is obtained. Note that when both the respective pixel electrodes and the common electrode 213 transmit light, a dual-emission display panel can be obtained.

A protective layer 221 is provided over the common electrode 213 so as to cover the light-emitting elements 210R, 210G, and 210B. The protective layer 221 has a function of preventing diffusion of impurities such as water into each light-emitting element from above.

The pixel electrode 211 preferably has an end portion with a tapered shape. In the case where the pixel electrode 211 has an end portion with a tapered shape, the organic layer 212 that is provided along the end portion of the pixel electrode 211 can also have an inclined shape. When the end portion of the pixel electrode 211 has a tapered shape, coverage with the organic layer 212 provided to cover the end portion of the pixel electrode 211 can be improved. The side surface of the pixel electrode 211 having such a tapered shape is preferred because it allows a foreign matter (such as dust or particles) mixing during the manufacturing process to be easily removed by treatment such as cleaning.

In this specification and the like, a tapered shape indicates a shape in which at least part of a side surface of a structure is inclined to a substrate surface. For example, a tapered shape preferably includes a region where the angle between the inclined side surface and the substrate surface (such an angle is also referred to as a taper angle) is less than 90°.

The organic layer 212 has an island shape as a result of processing by photolithography. Thus, the angle formed between a top surface and a side surface of an end portion of the organic layer 212 is approximately 90°. By contrast, an organic film formed using a fine metal mask (FMM) or the like has a thickness that tends to gradually decrease with decreasing distance to an end portion, and has a top surface forming a slope in an area extending greater than or equal to 1 μm and less than or equal to 10 μm from the end portion, for example; thus, such an organic film has a shape whose top surface and side surface cannot be easily distinguished from each other.

An insulating layer 225, a resin layer 226, and a layer 228 are included between two adjacent light-emitting elements.

Between two adjacent light-emitting elements, a side surface of the organic layer 212 of one light-emitting element faces a side surface of the organic layer 212 of the other light-emitting element with the resin layer 226 between the side surfaces. The resin layer 226 is positioned between two adjacent light-emitting elements so as to fill the region between the end portions of their organic layers 212 and the region between the two organic layers 212. The resin layer 226 has a top surface with a smooth convex shape. The top surface of the resin layer 226 is covered with the common layer 214 and the common electrode 213.

The resin layer 226 functions as a planarization film that fills a step between two adjacent light-emitting elements. Providing the resin layer 226 can prevent a phenomenon in which the common electrode 213 is divided by a step at an end portion of the organic layer 212 (also referred to as disconnection) from occurring and the common electrode 213 over the organic layer 212 from being insulated.

An insulating layer containing an organic material can be suitably used as the resin layer 226. Examples of materials used for the resin layer 226 include an acrylic resin, a polyimide resin, an epoxy resin, an imide resin, a polyamide resin, a polyimide-amide resin, a silicone resin, a siloxane resin, a benzocyclobutene-based resin, a phenol resin, and precursors of these resins. The resin layer 226 may be formed using an organic material such as polyvinyl alcohol (PVA), polyvinyl butyral, polyvinylpyrrolidone, polyethylene glycol, polyglycerin, pullulan, water-soluble cellulose, or an alcohol-soluble polyamide resin.

A photosensitive resin can also be used for the resin layer 226. A photoresist may be used for the photosensitive resin. As the photosensitive resin, a positive photosensitive material or a negative photosensitive material can be used.

The resin layer 226 may contain a material absorbing visible light. For example, the resin layer 226 itself may be made of a material absorbing visible light, or the resin layer 226 may contain a pigment absorbing visible light. For example, the resin layer 226 can be formed using a resin that can be used as a color filter transmitting red, blue, or green light and absorbing light of the other colors; or a resin that contains carbon black as a pigment and functions as a black matrix.

The insulating layer 225 is provided to be in contact with the side surface of the organic layer 212 and to cover an upper end portion of the organic layer 212. Part of the insulating layer 225 is in contact with the top surface of the substrate 201.

The insulating layer 225 is positioned between the resin layer 226 and the organic layer 212 to function as a protective film for preventing contact between the resin layer 226 and the organic layer 212. In the case of bringing the resin layer 226 into contact with the organic layer 212, the organic layer 212 might be dissolved by an organic solvent or the like used in formation of the resin layer 226. In view of this, the insulating layer 225 is provided between the organic layer 212 and the resin layer 226 to protect the side surface of the organic layer 212.

The insulating layer 225 can be an insulating layer containing an inorganic material. As the insulating layer 225, an inorganic insulating film such as an oxide insulating film, a nitride insulating film, an oxynitride insulating film, or a nitride oxide insulating film can be used, for example. The insulating layer 225 may have a single-layer structure or a stacked-layer structure. Examples of the oxide insulating film include a silicon oxide film, an aluminum oxide film, a magnesium oxide film, an indium gallium zinc oxide film, a gallium oxide film, a germanium oxide film, an yttrium oxide film, a zirconium oxide film, a lanthanum oxide film, a neodymium oxide film, a hafnium oxide film, and a tantalum oxide film. Examples of the nitride insulating film include a silicon nitride film and an aluminum nitride film. Examples of the oxynitride insulating film include a silicon oxynitride film and an aluminum oxynitride film. Examples of the nitride oxide insulating film include a silicon nitride oxide film and an aluminum nitride oxide film. In particular, when a metal oxide film such as an aluminum oxide film or a hafnium oxide film or an inorganic insulating film such as a silicon oxide film that is formed by an ALD method is used as the insulating layer 225, the insulating layer 225 has a small number of pin holes and excels in a function of protecting the EL layer.

Note that in this specification and the like, oxynitride refers to a material in which an oxygen content is higher than a nitrogen content, and nitride oxide refers to a material in which a nitrogen content is higher than an oxygen content. For example, silicon oxynitride refers to a material in which an oxygen content is higher than a nitrogen content, and silicon nitride oxide refers to a material in which a nitrogen content is higher than an oxygen content.

The insulating layer 225 can be formed by a sputtering method, a CVD method, a PLD method, an ALD method, or the like. The insulating layer 225 is preferably formed by an ALD method achieving good coverage.

Between the insulating layer 225 and the resin layer 226, a reflective film (e.g., a metal film containing one or more of silver, palladium, copper, titanium, aluminum, and the like) may be provided to reflect the light that is emitted from the light-emitting layer. In this case, the light extraction efficiency can be increased.

Part of a protective layer (also referred to as a mask layer or a sacrificial layer) for protecting the organic layer 212 during etching of the organic layer 212 survives the etching to become the layer 228. For the layer 228, the material that can be used for the insulating layer 225 can be used. Particularly, the layer 228 and the insulating layer 225 are preferably formed with the same material, in which case an apparatus or the like for processing can be used in common.

In particular, a metal oxide film such as an aluminum oxide film or a hafnium oxide film and an inorganic insulating film such as a silicon oxide film which are formed by an ALD method have a small number of pinholes, and thus excel in the function of protecting the EL layer and are preferably used for the insulating layer 225 and the layer 228.

The protective layer 221 can have, for example, a single-layer structure or a stacked-layer structure at least including an inorganic insulating film. Examples of the inorganic insulating film include an oxide film or a nitride film such as a silicon oxide film, a silicon oxynitride film, a silicon nitride oxide film, a silicon nitride film, an aluminum oxide film, an aluminum oxynitride film, or a hafnium oxide film. Alternatively, a semiconductor material or a conductive material such as indium gallium oxide, indium zinc oxide, indium tin oxide, or indium gallium zinc oxide may be used for the protective layer 221.

As the protective layer 221, a stacked film of an inorganic insulating film and an organic insulating film can be used. For example, a structure in which an organic insulating film is sandwiched between a pair of inorganic insulating films is preferable. Furthermore, it is preferred that the organic insulating film function as a planarization film. With this structure, a top surface of the organic insulating film can be flat, and accordingly, coverage with the inorganic insulating film over the organic insulating film is improved, leading to an improvement in barrier properties. Moreover, since the top surface of the protective layer 221 is flat, a preferable effect can be obtained; when a component (e.g., a color filter, an electrode of a touch sensor, a lens array, or the like) is provided above the protective layer 221, the component is less affected by an uneven shape caused by the lower structure.

FIG. 25C illustrates the connection portion 240 in which the connection electrode 211C is electrically connected to the common electrode 213. In the connection portion 240, an opening portion is provided in the insulating layer 225 and the resin layer 226 over the connection electrode 211C. In the opening portion, the connection electrode 211C and the common electrode 213 are electrically connected to each other.

Although FIG. 25C illustrates the connection portion 240 in which the connection electrode 211C and the common electrode 213 are electrically connected to each other, the common electrode 213 may be provided over the connection electrode 211C with the common layer 214 therebetween. Particularly in the case of the common layer 214 that includes a carrier-injection layer, for example, the common layer 214 can be formed to be thin using a material with sufficiently low electrical resistivity and thus can be in the connection portion 240 almost without causing any problem. Accordingly, the common electrode 213 and the common layer 214 can be formed using the same shielding mask, whereby manufacturing costs can be reduced.

### Structure Example 2

A display panel partly different from Structure example 1 is described below. Note that Structure example 1 is referred to for the same portions and the description is skipped here in some cases.

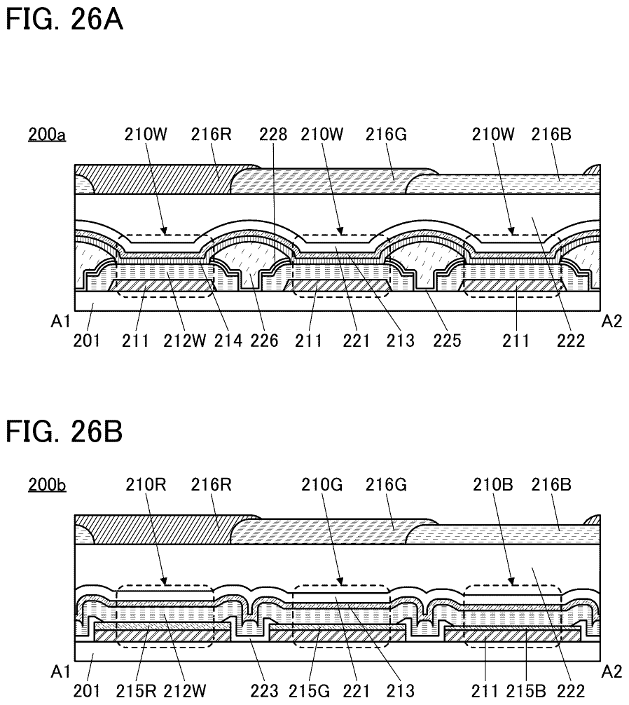

FIG. 26A is a schematic cross-sectional view of a display panel 200a. The display panel 200a is different from the display panel 200 mainly in the structure of the light-emitting element and including a coloring layer.

The display panel 200a includes a light-emitting element 210W emitting white light. The light-emitting element 210W includes the pixel electrode 211, an organic layer 212W, the common layer 214, and the common electrode 213. The organic layer 212W emits white light. For example, the organic layer 212W can contain two or more kinds of light-emitting materials that emit light of complementary colors. For example, the organic layer 212W can contain a light-emitting organic compound emitting red light, a light-emitting organic compound emitting green light, and a light-emitting organic compound emitting blue light. Alternatively, the organic layer 212W may contain a light-emitting organic compound emitting blue light and a light-emitting organic compound emitting yellow light.

The organic layer 212W is divided between the two adjacent light-emitting elements 210W. Thus, leakage current that might flow between the adjacent light-emitting elements 210W through the organic layer 212W can be inhibited and crosstalk due to the leakage current can be inhibited. Accordingly, the display panel can have high contrast and high color reproducibility.

An insulating layer 222 functioning as a planarization film is provided over the protective layer 221, and a coloring layer 216R, a coloring layer 216G, and a coloring layer 216B are provided over the insulating layer 222.

An organic resin film or an inorganic insulating film with a flat top surface can be used as the insulating layer 222. The insulating layer 222 is a formation surface on which the coloring layer 216R, the coloring layer 216G, and the coloring layer 216B are formed. Thus, with a flat top surface of the insulating layer 222, the thickness of the coloring layer 216R or the like can be uniform and color purity can be increased. Note that if the thickness of the coloring layer 216R or the like is not uniform, the amount of light absorption varies depending on a region in the coloring layer 216R, which might decrease color purity of light extracted from each light-emitting element.

### Structure Example 3

FIG. 26B is a schematic cross-sectional view of a display panel 200b.

The light-emitting element 210R includes the pixel electrode 211, a conductive layer 215R, the organic layer 212W, and the common electrode 213. The light-emitting element 210G includes the pixel electrode 211, a conductive layer 215G, the organic layer 212W, and the common electrode 213. The light-emitting element 210B includes the pixel electrode 211, a conductive layer 215B, the organic layer 212W, and the common electrode 213. The conductive layers 215R, 215G, and 215B each have a light-transmitting property and function as an optical adjustment layer.

A film reflecting visible light is used for the pixel electrode 211 and a film having a property of reflecting and transmitting visible light is used for the common electrode 213, whereby a micro optical resonator (microcavity) structure can be obtained. In this case, by adjusting the thicknesses of the conductive layers 215R, 215G, and 215B to obtain optimal optical path lengths, light with different wavelengths and increased intensities can be extracted from the light-emitting elements 210R, 210G, and 210B even when the organic layer 212W emitting white light is used.

Furthermore, the coloring layers 216R, 216G, and 216B are provided on the optical paths of the light-emitting elements 210R, 210G, and 210B, respectively, whereby light with high color purity can be extracted from each light-emitting element.

An insulating layer 223 that covers end portions of the pixel electrode 211 and the conductive layers 215R, 215G, and 215B are provided. The insulating layer 223 preferably has an end portion with a tapered shape. The insulating layer 223 can increase coverage with the organic layer 212W, the common electrode 213, the protective layer 221, and the like provided over the insulating layer 223.

The organic layer 212W and the common electrode 213 are each provided as one continuous film shared by the light-emitting elements. Such a structure is preferable because the manufacturing process of the display panel can be greatly simplified.

Here, the end portion of the pixel electrode 211 preferably has a substantially perpendicular shape. In this manner, a steep portion can be formed on the surface of the insulating layer 223, and thus part of the organic layer 212W covering the steep portion can have a small thickness or part of the organic layer 212W can be divided. Accordingly, leakage current generated between adjacent light-emitting elements through the organic layer 212W can be inhibited without processing the organic layer 212W by photolithography or the like.

The above is the description of the structure example of the display panel.

### [Pixel Layout]

Pixel layouts different from the layout in FIG. 25A will be mainly described below. There is no particular limitation on the arrangement of the light-emitting elements (subpixels), and a variety of methods can be employed.

Examples of a top surface shape of the subpixel include polygons such as a triangle, a tetragon (including a rectangle and a square), and a pentagon; polygons with rounded corners; an ellipse; and a circle. Here, a top surface shape of the subpixel corresponds to a top surface shape of a light-emitting region of the light-emitting element.

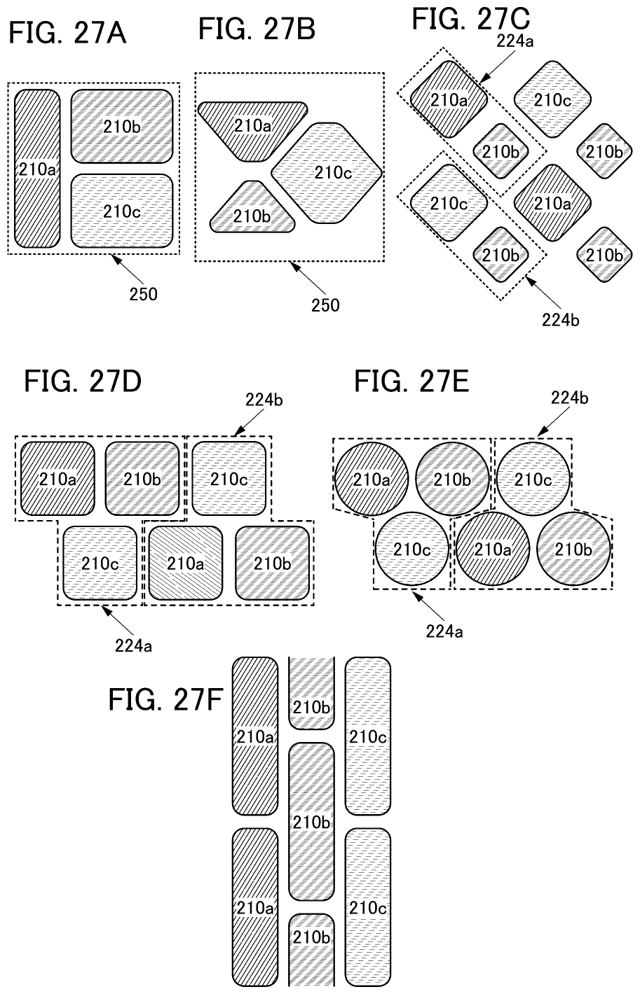

A pixel 250 illustrated in FIG. 27A employs S-stripe arrangement. The pixel 250 in FIG. 27A consists of three subpixels: light-emitting elements 210a, 210b, and 210c. For example, the light-emitting element 210a may be a blue-light-emitting element, the light-emitting element 210b may be a red-light-emitting element, and the light-emitting element 210c may be a green-light-emitting element.

The pixel 250 illustrated in FIG. 27B includes the light-emitting element 210a whose top surface has a rough trapezoidal or rough triangle shape with rounded corners, the light-emitting element 210b whose top surface has a rough trapezoidal or rough triangle shape with rounded corners, and the light-emitting element 210c whose top surface has a rough tetragonal or rough hexagonal shape with rounded corners. The light-emitting element 210a has a larger light-emitting area than the light-emitting element 210b. In this manner, the shapes and sizes of the light-emitting elements can be determined independently. For example, the size of a light-emitting element with higher reliability can be smaller. For example, the light-emitting element 210a may be a green-light-emitting element, the light-emitting element 210b may be a red-light-emitting element, and the light-emitting element 210c may be a blue-light-emitting element.

Pixels 224a and 224b illustrated in FIG. 27C employ PenTile arrangement. FIG. 27C illustrates an example in which the pixels 224a including the light-emitting elements 210a and 210b and the pixels 224b including the light-emitting elements 210b and 210c are alternately arranged. For example, the light-emitting element 210a may be a red-light-emitting element, the light-emitting element 210b may be a green-light-emitting element, and the light-emitting element 210c may be a blue-light-emitting element.

The pixels 224a and 224b illustrated in FIGS. 27D and 27E employ delta arrangement. The pixel 224a includes two light-emitting elements (the light-emitting elements 210a and 210b) in the upper row (first row) and one light-emitting element (the light-emitting element 210c) in the lower row (second row). The pixel 224b includes one light-emitting element (the light-emitting element 210c) in the upper row (first row) and two light-emitting elements (the light-emitting elements 210a and 210b) in the lower row (second row). For example, the light-emitting element 210a may be a red-light-emitting element, the light-emitting element 210b may be a green-light-emitting element, and the light-emitting element 210c may be a blue-light-emitting element.

FIG. 27D illustrates an example where the top surface of each light-emitting element has a rough tetragonal shape with rounded corners, and FIG. 27E illustrates an example where the top surface of each light-emitting element is circular.

FIG. 27F illustrates an example where light-emitting elements of different colors are arranged in a zigzag manner. Specifically, the positions of the top sides of two light-emitting elements arranged in the row direction (e.g., the light-emitting element 210a and the light-emitting element 210b or the light-emitting element 210b and the light-emitting element 210c) are not aligned in the top view. For example, the light-emitting element 210a may be a red-light-emitting element, the light-emitting element 210b may be a green-light-emitting element, and the light-emitting element 210c may be a blue-light-emitting element.

In photolithography, as a pattern to be formed by processing becomes finer, the influence of light diffraction becomes more difficult to ignore; therefore, the fidelity in transferring a photomask pattern by light exposure is degraded, and it becomes difficult to process a resist mask into a desired shape. Thus, a pattern with rounded corners is likely to be formed even with a rectangular photomask pattern. Consequently, a top surface of a light-emitting element may have a polygonal shape with rounded corners, an elliptical shape, a circular shape, or the like.

Furthermore, in the method for manufacturing the display panel of one embodiment of the present invention, the EL layer is processed into an island shape with the use of a resist mask. A resist film formed over the EL layer needs to be cured at a temperature lower than the upper temperature limit of the EL layer. Therefore, the resist film is insufficiently cured in some cases depending on the upper temperature limit of the material of the EL layer and the curing temperature of the resist material. An insufficiently cured resist film may have a shape different from a desired shape by processing. As a result, a top surface of the EL layer may have a polygonal shape with rounded corners, an elliptical shape, a circular shape, or the like. For example, when a resist mask with a square top surface is intended to be formed, a resist mask with a circular top surface may be formed, and the top surface of the EL layer may be circular.

To obtain a desired top surface shape of the EL layer, a technique of correcting a mask pattern in advance so that a transferred pattern agrees with a design pattern (an optical proximity correction (OPC) technique) may be used. Specifically, with the OPC technique, a pattern for correction is added to a corner portion or the like of a figure on a mask pattern.

The above is the description of the pixel layouts.

At least part of this embodiment can be implemented in combination with any of the other embodiments described in this specification, as appropriate.

### Embodiment 5

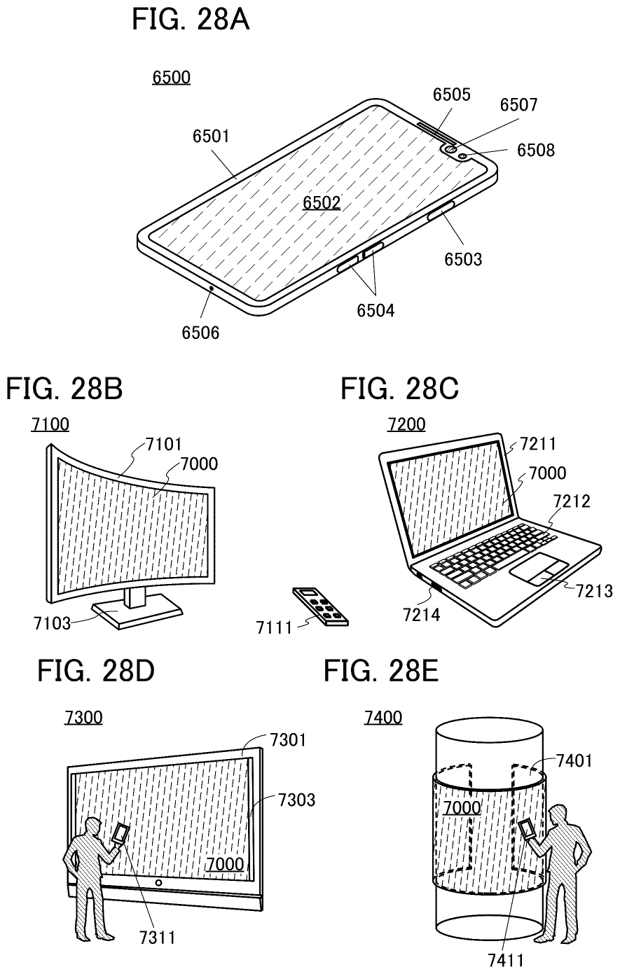

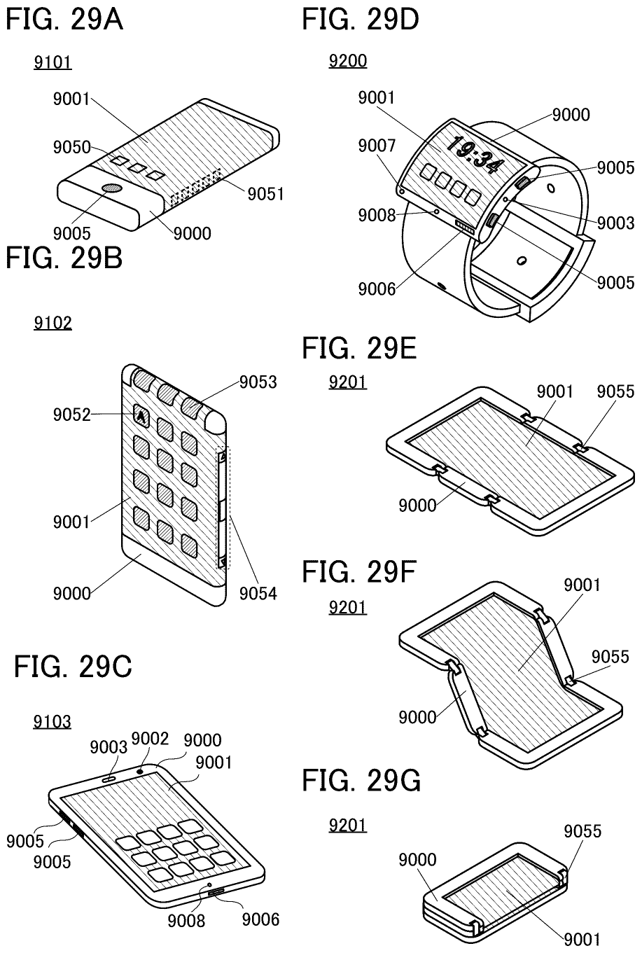

In this embodiment, electronic devices of one embodiment of the present invention will be described with reference to FIGS. 28A to 28E and FIGS. 29A to 29G.

Electronic devices in this embodiment each include a display device including the semiconductor device of one embodiment of the present invention in a display portion. The display device using the semiconductor device of one embodiment of the present invention can have high reliability and durability for long-term use. Thus, the product lifetime can be extended.

Examples of the electronic devices include a digital camera, a digital video camera, a digital photo frame, a mobile phone, a portable game console, a portable information terminal, and an audio reproducing device, in addition to electronic devices with a relatively large screen, such as a television device, desktop and laptop personal computers, a monitor of a computer and the like, digital signage, and a large game machine such as a pachinko machine.

The definition of the display device of one embodiment of the present invention is preferably as high as HD (number of pixels: 1280×720), FHD (number of pixels: 1920×1080), WQHD (number of pixels: 2560×1440), WQXGA (number of pixels: 2560×1600), 4K (number of pixels: 3840×2160), or 8K (number of pixels: 7680×4320). In particular, a definition of 4K, 8K, or higher is preferable. There is no particular limitation on the screen ratio (aspect ratio) of the display device of one embodiment of the present invention. For example, the display device is compatible with a variety of screen ratios such as 1:1 (a square), 4:3, 16:9, and 16:10.

The electronic device in this embodiment may include a sensor (a sensor having a function of sensing, detecting, or measuring force, displacement, position, speed, acceleration, angular velocity, rotational frequency, distance, light, liquid, magnetism, temperature, a chemical substance, sound, time, hardness, electric field, current, voltage, electric power, radiation, flow rate, humidity, gradient, oscillation, a smell, or infrared rays).

The electronic device in this embodiment can have a variety of functions. For example, the electronic device in this embodiment can have a function of displaying a variety of information (a still image, a moving image, a text image, and the like) on the display portion, a touch panel function, a function of displaying a calendar, date, time, and the like, a function of executing a variety of software (programs), a wireless communication function, and a function of reading out a program or data stored in a recording medium.

An electronic device 6500 illustrated in FIG. 28A is a portable information terminal that can be used as a smartphone.

The electronic device 6500 includes a housing 6501, a display portion 6502, a power button 6503, buttons 6504, a speaker 6505, a microphone 6506, a camera 6507, a light source 6508, and the like. The display portion 6502 has a touch panel function. The display device including the semiconductor device of one embodiment of the present invention can be used for the display portion 6502.

FIG. 28B lustrates an example of a television device. In a television device 7100, a display portion 7000 is incorporated in a housing 7101. Here, the housing 7101 is supported by a stand 7103. The display device including the semiconductor device of one embodiment of the present invention can be used for the display portion 7000.

Operation of the television device 7100 can be performed with an operation switch provided in the housing 7101 and a separate remote controller 7111. Alternatively, the display portion 7000 may include a touch sensor, and the television device 7100 may be operated by touch on the display portion 7000 with a finger or the like. The remote controller 7111 may be provided with a display portion for displaying information output from the remote controller 7111. With operation keys or a touch panel provided in the remote controller 7111, channels and volume can be controlled and videos displayed on the display portion 7000 can be controlled. Note that the television device 7100 includes a receiver, a modem, and the like. A general television broadcast can be received with the receiver. When the television device is connected to a communication network by wire or wirelessly via the modem, one-way (from a transmitter to a receiver) or two-way (between a transmitter and a receiver or between receivers, for example) data communication can be performed.

FIG. 28C illustrates an example of a laptop personal computer. A laptop personal computer 7200 includes a housing 7211, a keyboard 7212, a pointing device 7213, an external connection port 7214, and the like. The display portion 7000 is incorporated in the housing 7211. The display device including the semiconductor device of one embodiment of the present invention can be used for the display portion 7000.

FIGS. 28D and 28E illustrate examples of digital signage. Digital signage 7300 illustrated in FIG. 28D includes a housing 7301, the display portion 7000, a speaker 7303, and the like. The digital signage 7300 can also include an LED lamp, an operation key (including a power switch or an operation switch), a connection terminal, a variety of sensors, a microphone, and the like.

FIG. 28E illustrates digital signage 7400 attached to a cylindrical pillar 7401. The digital signage 7400 includes the display portion 7000 provided along a curved surface of the pillar 7401. In FIGS. 28D and 28E, the display device including the semiconductor device of one embodiment of the present invention can be used for the display portion 7000.

A larger area of the display portion 7000 can increase the amount of information that can be provided at a time. The larger display portion 7000 attracts more attention, so that the effectiveness of the advertisement can be increased, for example.

The use of a touch panel in the display portion 7000 is preferable because in addition to display of a still image or a moving image on the display portion 7000, intuitive operation by a user is possible. Moreover, for an application for providing information such as route information or traffic information, usability can be enhanced by intuitive operation.

It is preferable that the digital signage 7300 or the digital signage 7400 can work with an information terminal 7311 or an information terminal 7411, such as a smartphone that a user has, through wireless communication. For example, information of an advertisement displayed on the display portion 7000 can be displayed on a screen of the information terminal 7311 or the information terminal 7411. By operation of the information terminal 7311 or the information terminal 7411, display on the display portion 7000 can be switched.

It is possible to make the digital signage 7300 or the digital signage 7400 execute a game with use of the screen of the information terminal 7311 or the information terminal 7411 as an operation means (controller). Thus, an unspecified number of users can join in and enjoy the game concurrently.

Electronic devices illustrated in FIGS. 29A to 29G include a housing 9000, a display portion 9001, a speaker 9003, an operation key 9005 (including a power switch or an operation switch), a connection terminal 9006, a sensor 9007 (a sensor having a function of sensing, detecting, or measuring force, displacement, position, speed, acceleration, angular velocity, rotational frequency, distance, light, liquid, magnetism, temperature, a chemical substance, sound, time, hardness, electric field, current, voltage, electric power, radiation, flow rate, humidity, gradient, oscillation, a smell, or infrared rays), a microphone 9008, and the like.

The electronic devices illustrated in FIGS. 29A to 29G have a variety of functions. For example, the electronic devices can have a function of displaying a variety of information (a still image, a moving image, a text image, and the like) on the display portion, a touch panel function, a function of displaying a calendar, date, time, and the like, a function of controlling processing with the use of a variety of software (programs), a wireless communication function, and a function of reading out and processing a program or data stored in a recording medium. Note that the functions of the electronic devices are not limited thereto, and the electronic devices can have a variety of functions. The electronic devices may include a plurality of display portions. The electronic devices may be provided with a camera or the like and have a function of capturing a still image or a moving image, a function of storing the captured image in a storage medium (an external storage medium or a storage medium incorporated in the camera), a function of displaying the captured image on the display portion, and the like.

The details of the electronic devices illustrated in FIGS. 29A to 29G are described below. Note that the display device including the semiconductor device of one embodiment of the present invention can be used in these electronic devices.

FIG. 29A is a perspective view of a portable information terminal 9101. The portable information terminal 9101 can be used as a smartphone, for example. The portable information terminal 9101 may include the speaker 9003, the connection terminal 9006, the sensor 9007, or the like. The portable information terminal 9101 can display text and image information on its plurality of surfaces. FIG. 29A illustrates an example where three icons 9050 are displayed. Furthermore, information 9051 indicated by dashed rectangles can be displayed on another surface of the display portion 9001. Examples of the information 9051 include notification of reception of an e-mail, an SNS message, or an incoming call, the title and sender of an e-mail, an SNS message, or the like, the date, the time, remaining battery, and the radio field intensity. Alternatively, the icon 9050 or the like may be displayed at the position where the information 9051 is displayed.

FIG. 29B is a perspective view of a portable information terminal 9102. The portable information terminal 9102 has a function of displaying information on three or more surfaces of the display portion 9001. Here, information 9052, information 9053, and information 9054 are displayed on different surfaces. The user of the portable information terminal 9102 can check the information 9053 displayed such that it can be seen from above the portable information terminal 9102, with the portable information terminal 9102 put in a breast pocket of his/her clothes. Thus, the user can see the display without taking out the portable information terminal 9102 from the pocket and decide whether to answer the call.

FIG. 29C is a perspective view of a tablet terminal 9103. The tablet terminal 9103 is capable of executing a variety of applications such as mobile phone calls, e-mailing, viewing and editing texts, music reproduction, Internet communication, and a computer game, for example. The tablet terminal 9103 includes the display portion 9001, the camera 9002, the microphone 9008, and the speaker 9003 on the front surface of the housing 9000; the operation keys 9005 as buttons for operation on the left side surface of the housing 9000; and the connection terminal 9006 on the bottom surface of the housing 9000.

FIG. 29D is a perspective view of a watch-type portable information terminal 9200. The portable information terminal 9200 can be used as a Smartwatch (registered trademark), for example. The display surface of the display portion 9001 is curved, and an image can be displayed on the curved display surface. Furthermore, mutual communication between the portable information terminal 9200 and a headset capable of wireless communication can be performed, and thus hands-free calling is possible. With the connection terminal 9006, the portable information terminal 9200 can perform mutual data transmission with another information terminal and charging. Note that the charging operation may be performed by wireless power feeding.

FIGS. 29E to 29G are perspective views of a foldable portable information terminal 9201. FIG. 29E is a perspective view illustrating the portable information terminal 9201 that is opened. FIG. 29G is a perspective view illustrating the portable information terminal 9201 that is folded. FIG. 29F is a perspective view illustrating the portable information terminal 9201 that is shifted from one of the states in FIGS. 29E and 29G to the other. The portable information terminal 9201 is highly portable when folded. When the portable information terminal 9201 is opened, a seamless large display region is highly browsable. The display portion 9001 of the portable information terminal 9201 is supported by three housings 9000 joined together by hinges 9055. The display portion 9001 can be folded with a radius of curvature greater than or equal to 0.1 mm and less than or equal to 150 mm, for example.

At least part of this embodiment can be implemented in combination with any of the other embodiments described in this specification, as appropriate.

This application is based on Japanese Patent Application Serial No. 2023-103031 filed with Japan Patent Office on Jun. 23, 2023, the entire contents of which are hereby incorporated by reference.

What is claimed is:

1. A semiconductor device comprising:
a first switch; and
a second switch,
wherein the first switch comprises a first transistor, a second transistor, and a third transistor,
wherein a drain of the first transistor is electrically connected to a high potential power supply line,
wherein a source of the first transistor is electrically connected to a drain of the second transistor,
wherein the drain of the second transistor is electrically connected to a gate and a drain of the third transistor,
wherein a source of the second transistor is electrically connected to a source of the third transistor,
wherein a gate of the first transistor is electrically connected to a gate of the second transistor,
wherein the second switch comprises a fourth transistor, a fifth transistor, and a sixth transistor,
wherein a source of the fourth transistor is electrically connected to a low potential power supply line,
wherein a drain of the fourth transistor is electrically connected to a source of the fifth transistor,
wherein the source of the fifth transistor is electrically connected to a source of the sixth transistor,
wherein a drain of the fifth transistor is electrically connected to a gate and a drain of the sixth transistor,
wherein a gate of the fourth transistor is electrically connected to a gate of the fifth transistor, and
wherein the source of the second transistor and the drain of the fifth transistor are electrically connected to each other.

2. The semiconductor device according to claim 1,
wherein the third transistor comprises a first back gate,
wherein the sixth transistor comprises a second back gate,
wherein the first back gate is electrically connected to the source of the second transistor, and
wherein the second back gate is electrically connected to the source of the fourth transistor.

3. The semiconductor device according to claim 1,
wherein each of the first to sixth transistors comprises a metal oxide in a semiconductor layer and is provided with a channel formation region along a side surface of an insulating layer.

4. A display device comprising the semiconductor device according to claim 1, in a pixel driver circuit.

5. An electronic device comprising:
the display device according to claim 4; and
a speaker.

6. A semiconductor device comprising:
a first switch; and
a second switch,
wherein the first switch comprises a first transistor, a second transistor, a third transistor, a fourth transistor, a fifth transistor, a sixth transistor, and a seventh transistor,
wherein a drain of the first transistor is electrically connected to a high potential power supply line,
wherein a source of the first transistor is electrically connected to a drain of the second transistor and a gate and a drain of the fifth transistor,
wherein a source of the second transistor is electrically connected to a drain of the third transistor, a source of the fifth transistor, and a gate and a drain of the sixth transistor,
wherein a source of the third transistor is electrically connected to a drain of the fourth transistor, a source of the sixth transistor, and a gate and a drain of the seventh transistor,
wherein a source of the fourth transistor is electrically connected to a source of the seventh transistor,
wherein gates of the first to fourth transistors and the gates of the fifth to seventh transistors are electrically connected to each other,
wherein the second switch comprises an eighth transistor, a ninth transistor, a tenth transistor, an eleventh transistor, a twelfth transistor, a thirteenth transistor, and a fourteenth transistor,
wherein a source of the eighth transistor is electrically connected to a low potential power supply line,
wherein a drain of the eighth transistor is electrically connected to a source of the ninth transistor and a source of the twelfth transistor,
wherein a drain of the ninth transistor is electrically connected to a source of the tenth transistor, a gate and a drain of the twelfth transistor, and a source of the thirteenth transistor,
wherein a drain of the tenth transistor is electrically connected to a source of the eleventh transistor, a gate and a drain of the thirteenth transistor, and a source of the fourteenth transistor,
wherein a drain of the eleventh transistor is electrically connected to a gate and a drain of the fourteenth transistor,
wherein gates of the eighth to eleventh transistors and the gates of the twelfth to fourteenth transistors are electrically connected to each other, and
wherein the source of the fourth transistor and the drain of the eleventh transistor are electrically connected to each other.

7. The semiconductor device according to claim 6,
wherein the fifth transistor comprises a first back gate,
wherein the sixth transistor comprises a second back gate,
wherein the seventh transistor comprises a third back gate,
wherein the twelfth transistor comprises a fourth back gate,
wherein the thirteenth transistor comprises a fifth back gate,
wherein the fourteenth transistor comprises a sixth back gate,
wherein the first back gate is electrically connected to the source of the third transistor,
wherein the second back gate and the third back gate are electrically connected to the source of the fourth transistor,
wherein the fourth back gate is electrically connected to the source of the eighth transistor,
wherein the fifth back gate is electrically connected to the source of the ninth transistor, and
wherein the sixth back gate is electrically connected to the source of the tenth transistor.

8. The semiconductor device according to claim 6,
wherein the fifth transistor comprises a first back gate,
wherein the sixth transistor comprises a second back gate,
wherein the seventh transistor comprises a third back gate,
wherein the twelfth transistor comprises a fourth back gate,
wherein the thirteenth transistor comprises a fifth back gate,
wherein the fourteenth transistor comprises a sixth back gate,
wherein the first to third back gates are electrically connected to the source of the fourth transistor, and
wherein the fourth to sixth back gates are electrically connected to the source of the eighth transistor.

9. The semiconductor device according to claim 6,
wherein each of the first to fourteenth transistors comprises a metal oxide in a semiconductor layer and is provided with a channel formation region along a side surface of an insulating layer.

10. A display device comprising the semiconductor device according to claim 6, in a pixel driver circuit.

11. An electronic device comprising:
the display device according to claim 10; and
a speaker.
